(19) United States
(12) Patent Application Publication
(10) Pub. No.: US 2024/0341921 A1
(43) Pub. Date: Oct. 17, 2024

(54) DENTAL APPLIANCE OCCLUSAL ELEMENT

(71) Applicant: Align Technology, Inc., San Jose, CA (US)

(72) Inventors: James Nishimuta, Durham, NC (US); Jun Sato, San Jose, CA (US); Rohit Tanugula, San Jose, CA (US); Enrique Jonathan Guzman Olivas, Ciudad Juárez (MX); Jose Kiyotaka Blanco Romo, Ciudad Juárez (MX); Kevin Daniel Rodriguez Trujillo, Ciudad Juárez (MX)

(21) Appl. No.: 18/633,200

(22) Filed: Apr. 11, 2024

Related U.S. Application Data
(60) Provisional application No. 63/459,485, filed on Apr. 14, 2023.

(51) Int. Cl. A61C 7/08

(52) U.S. Cl. CPC A61C 7/08

(57) ABSTRACT

A dental appliance occlusal element includes a lower surface comprising one or more features configured to interface with a pick-and-place robot to cause the dental appliance occlusal element to be inserted into a hollow feature of a dental appliance. The dental appliance occlusal element further includes an upper surface configured to be disposed adjacent a distal inner surface of the hollow feature. The dental appliance occlusal element further includes one or more side surfaces configured to be disposed against one or more side inner surfaces of the hollow feature.

### RELATED APPLICATION

This application claims benefit of U.S. Provisional Application No. 63/459,485, filed Apr. 14, 2023, the content of which is hereby incorporated by reference in its entirety.

### TECHNICAL FIELD

The present disclosure relates to the field of manufacturing custom products and, in particular, to systems and methods for manufacturing custom dental appliances such as orthodontic aligners that include occlusal elements.

### BACKGROUND

For some applications, shells are formed around molds to achieve a negative of the mold. The shells are then removed from the molds to be further used for various applications. One example application in which a shell is formed around a mold and then later used is corrective dentistry or orthodontic treatment. In such an application, the mold may be a positive mold of a dental arch for a patient and the shell may be an aligner to be used for aligning one or more teeth of the patient. When attachments are used, the mold may also include features associated with planned orthodontic attachments and virtual fillers.

### SUMMARY

Various implementations of the present disclosure are summarized.

In a first implementation, a dental appliance occlusal element comprising: a lower surface comprising one or more features configured to interface with a pick-and-place robot to cause the dental appliance occlusal element to be inserted into a hollow feature of a dental appliance; an upper surface configured to be disposed adjacent a distal inner surface of the hollow feature; and one or more side surfaces configured to be disposed against one or more side inner surfaces of the hollow feature.

A second implementation may further extend the first implementation. In the second implementation, the one or more features comprise a first recess and a second recess, wherein the pick-and-place robot comprises a gripper comprising distal ends configured to secure the dental appliance occlusal element via the first recess and the second recess.

A third implementation may further extend the first or second implementation. In the third implementation, the one or more features comprises a channel, wherein the pick-and-place robot comprises a gripper comprising distal ends configured to secure the dental appliance occlusal element via the channel.

A fourth implementation may further extend any of the first through third implementations. In the fourth implementation, the one or more features comprise a substantially planar surface, wherein the pick-and-place robot comprises a vacuum configured to secure the dental appliance occlusal element via suction of the substantially planar surface.

A fifth implementation may further extend any of the first through fourth implementations. In the fifth implementation, the upper surface and at least one of the one or more side surfaces comprise an identifying feature configured to interface with a corresponding feature of the hollow feature.

A sixth implementation may further extend any of the first through fifth implementations. In the sixth implementation: the upper surface is a curved surface; the one or more side surfaces comprise a lower side surface an upper side surface; and the upper side surface is a chamfer.

A seventh implementation may further extend any of the first through sixth implementations. In the seventh implementation, the lower side surface is from about 5 to about 9 degrees from vertical.

An eighth implementation may further extend any of the first through seventh implementations. In the eighth implementation, the dental appliance occlusal element is solid.

In a nineth implementation, an overmolding occlusal element comprising: an upper surface; one or more side surfaces; and a lower surface forming a plurality of features configured to interface with a plurality of corresponding features of a dental mold, wherein a dental appliance is to be thermoformed over the dental mold and the overmolding occlusal element.

A tenth implementation may further extend the nineth implementation. In the tenth implementation, the upper surface is curved.

An eleventh implementation may further extend the nineth or tenth implementation. In the eleventh implementation, the upper surface forms one or more recesses.

A twelfth implementation may further extend any of the nineth through eleventh implementations. In the twelfth implementation, the plurality of features comprise a plurality of recesses formed by ribbed sidewalls.

A thirteenth implementation may further extend any of the nineth through twelfth implementations. In the thirteenth implementation, the plurality of features comprise a plurality of angled recesses.

A fourteenth implementation may further extend any of the nineth through thirteenth implementations. In the fourteenth implementation, the lower surface forms a stepped base configured to interface with the dental mold.

A fifteenth implementation may further extend any of the nineth through fourteenth implementations. In the fifteenth implementation, the one or more side surfaces form recesses configured to interface with a pick-and-place robot to cause the overmolding occlusal element to be secured to the dental mold.

A sixteenth implementation may further extend any of the nineth through fifteenth implementations. In the sixteenth implementation, the upper surface and at least one of the one or more side surfaces form a feature configured to form a corresponding feature in the dental appliance to interface with an occlusal element.

A seventeenth implementation may further extend any of the nineth through sixteenth implementations. In the seventeenth implementation, the upper surface comprises a curved surface, wherein the one or more side surfaces comprise an upper side surface and a lower side surface, wherein the upper side surface is chamfered, and wherein the lower side surface is about 5 to about 9 degrees.

An eighteenth implementation may further extend any of the nineth through seventeenth implementations. In the eighteenth implementation, the one or more side surfaces form a lip, wherein the lip is about 0.5 millimeters (mm) to about 1.0 mm.

A nineteenth implementation may further extend any of the nineth through eighteenth implementations. In the nineteenth implementation, at least one of the one or more side surfaces are tapered, wherein: the upper surface is wider than the lower surface; or the lower surface is wider than the upper surface.

In a twentieth implementation, a dental appliance mold comprising: a dental arch portion associated with a current or future dental arch of a user; and an occlusal element portion comprising: a curved upper surface; and one or more side surfaces forming a lip that is about 0.5 millimeters (mm) to about 1.0 mm, and wherein a dental appliance is configured to be thermoformed over the dental appliance mold, wherein a hollow feature of the dental appliance is to be formed over the occlusal element portion.

A twenty-first implementation may further extend the twentieth implementation. In the twenty-first implementation, the one or more side surfaces comprise an upper side surface and a lower side surface, and the upper side surface is chamfered, and wherein the lower side surface is about 5 to about 9 degrees.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-H and 2A-H illustrate occlusal elements, according to certain embodiments.

FIGS. 3A-F illustrate occlusal elements, according to certain embodiments.

FIGS. 4A-D illustrate occlusal elements, according to certain embodiments.

FIGS. 5A-J illustrate occlusal elements, according to certain embodiments.

FIGS. 6A-E illustrate holders associated with dental appliances, according to certain embodiments.

FIGS. 7A-B illustrate a pick-and-place robot, according to certain embodiments.

FIGS. 8A-B illustrate occlusal elements, according to certain embodiments.

FIGS. 9A-E illustrate occlusal elements, according to certain embodiments.

FIGS. 10A-K illustrate occlusal elements, according to certain embodiments.

FIG. 11 illustrates a method associated with manufacturing a dental appliance, according to certain embodiments.

FIG. 12 illustrates a flow diagram for a method of manufacturing a dental appliance, according to certain embodiments.

FIG. 13 illustrates a element diagram of an example computing device, according to certain

embodiments.

FIG. 14 illustrates a tooth repositioning system, in accordance with embodiments.

FIG. 15 illustrates a method of orthodontic treatment using a plurality of appliances, in accordance with embodiments.

FIG. 16 illustrates a method for designing an orthodontic appliance to be produced by direct fabrication, in accordance with embodiments.

FIG. 17 illustrates a method for digitally planning an orthodontic treatment, in accordance with embodiments.

### DETAILED DESCRIPTION OF THE DRAWINGS

The present disclosure is associated with occlusal elements (e.g., dental appliance occlusal elements, occlusal element design features for manufacturing). Occlusal elements may be used in manufacturing of a dental appliance (e.g., used with the mold for thermoforming of a dental appliance, inserted into a dental appliance after thermoforming, etc.).

Dental appliances such as orthodontic aligners may be shells thermoformed over a mold associated with a patient's dental arch. Typically, the molds over which the dental appliances are formed have a shape of a patient's dentition at a stage in treatment (e.g., at a stage in orthodontic treatment). For some types of treatment, the dental appliances are designed to have features (e.g., such as occlusal elements) that do not correspond to a patient's dentition. A mold over which the dental appliance is formed may include a mold section for such features, which can cause the dental appliance to have one or more cavities that are not to be filled by a patient's teeth. Such cavities can be weak points for the dental appliance and can crumple or otherwise fail while the dental appliance is worn by a patient.

There are numerous dental appliances (e.g., orthodontic appliances such as orthodontic aligners) that are traditionally used to correct different patient dental conditions. These various types of orthodontic appliances may be used to correct different types and severities of malocclusion (defined as abnormal alignment of the teeth and the way that the upper and lower teeth fit together). Orthodontic brackets (also known as braces) may be used with wires to correct some types of malocclusions. Conventional plastic orthodontic aligners may also be used to correct some types of malocclusions. However, some malocclusions may not be treatable using braces or conventional plastic orthodontic aligners. Additionally, some malocclusions may be treatable, but treatment of these malocclusions using current techniques for manufacturing plastic orthodontic aligners may introduce undesirable tradeoffs. Some aligner features for mandibular repositioning may have lower strength as compared to a twin element. For such malocclusions, additional orthodontic appliances that may be used on a patient include headgear, expansion appliances (e.g., a palatal expander), spacers, bite plates, Carrier® Distalizers™, functional appliances (e.g., an Andresen appliance, a Bionator, a Hawley retainer, a twin element, a Herbst appliance, a Forsus appliance, etc.), and so on. Additionally, other types of dental appliances may be used on patients for the treatment of sleep apnea and other conditions.

Current plastic aligners may introduce tradeoffs when used to correct malocclusions that are traditionally corrected through the use of some of the aforementioned additional orthodontic appliances. Current plastic aligners may be susceptible to crushing when used for some geometries such as large undercuts or complex features.

The systems, devices, components, and methods described herein overcome these and other shortcomings. In some embodiments, an occlusal element (e.g., dental appliance occlusal element, overmolding occlusal element) includes a lower surface, an upper surface, and one or more side surfaces.

In some embodiments, the occlusal element is to be inserted into a hollow feature of a dental appliance. The upper surface is configured to be disposed adjacent a distal inner surface of the hollow feature. The side surfaces are configured to be disposed against side inner surfaces of the hollow feature. The lower surface may include one or more features that are configured to interface with a pick-and-place robot to cause the occlusal element to be inserted into a hollow feature of a dental appliance. The features may include one or more recesses, where a gripper of the pick-and-place robot is configured to secure the occlusal element via the recesses. The features may include a substantially planar surface, where a vacuum of the pick-and-place robot is configured to secure the dental appliance via the vacuum. The occlusal element may be bonded to the dental appliance subsequent to being inserted into the hollow feature of the dental appliance.

In some embodiments, the dental appliance is thermoformed over a dental mold that includes an occlusal element (e.g., overmolding occlusal element) to form the hollow feature of the dental appliance. The occlusal element may include a lower surface that features configured to interface with corresponding features of a dental mold.

The present disclosure has advantages over conventional solutions. The present disclosure may provide for manufacturing orthodontic aligners having features that enable the orthodontic aligners to apply forces to correct malocclusions. These features may be hollow features that are less susceptible to being crushed in the present disclosure compared to conventional solutions. In some embodiments, cavities of the features are at least partially filled with objects (e.g., occlusal elements) that may provide structural strength to the features to prevent the features from being crushed or otherwise damaged. Insertion of the objects into the hollow features may additionally or alternatively improve hygiene associated with the plastic aligner compared to conventional solutions. The objects may also provide other benefits and/or perform other functions in addition to or instead of providing structural strength. The features and objects may also be used for numerous other purposes, such as jaw repositioning, to create joints in the plastic aligner, to alter mechanical properties of the plastic aligner, to alter occlusal contacts, to treat temporomandibular joint disorder (TMD), to enable linkages and/or locks to be applied to plastic aligners, to provide compliance indicators, to provide sensors, to provide buttons, and so on. In some embodiments, the objects are inserted into the cavities of the features of the orthodontic aligners and a bonding process is then performed to bond the objects to the orthodontic aligners. An example bonding process that may be used is a laser welding process. Once an object is bonded to an orthodontic appliance, the object may not dislodge from the orthodontic appliance and may not cause a choking hazard to the patient.

An orthodontic aligner as described herein may be included in a series of orthodontic aligners so as to provide an orthodontic system for positioning teeth. Such an orthodontic system can include a sequence of orthodontic aligners each including a shell (e.g., a plastic shell) having a one or more regions shaped to receive at least portions of teeth. The orthodontic aligners may be worn by a patient to move one or more teeth from a first arrangement to a second arrangement. One or more of the orthodontic aligners may include hollow features that are at least partially filled with additional objects.

Some embodiments are discussed herein with regards to orthodontic aligners. However, embodiments discussed with reference to orthodontic aligners are also applicable to other shells and/or dental appliances that are used for other purposes, such as orthodontic retainers, orthodontic splints, shells to be used as night guards, shells that are to be used to treat sleep apnea, and so on. Accordingly, any reference to orthodontic aligners also applies to other types of shells and/or dental appliances (e.g., other types of shells such as orthodontic retainers, orthodontic splints, or other shells that fit onto a patient's teeth but that do not reposition the patient's teeth or jaw).

Various software and/or hardware components may be used to implement the disclosed embodiments. For example, a robot arm may be configured to pick objects and place them against features (e.g., insert into hollow feature) of a dental appliance, a press may be configured to press an object against a dental appliance, a robot arm may be configured to direct a laser to perform a laser weld of an object to a dental appliance, and so on. In some embodiments, software components may include computer instructions stored in a tangible, non-transitory computer-readable media that are executed by one or more processing devices to perform machine based analysis and/or defect detection of dental appliances with bonded objects. The software may setup and calibrate one or more cameras included in the hardware components, capture images of dental appliances and/or objects from one or more angles using the one or more cameras, setup and calibrate a light source included in the hardware components, perform analysis that determines whether an aligner has been correctly placed in a holder, whether a correct object has been placed against a feature (e.g., into a cavity of a feature) of the dental appliance, whether an object has been correctly placed against a feature of the dental appliance, whether the object has been properly bonded to the dental appliance, and so on, optionally using one or more trained machine learning models.

An “occlusal element,” as used herein, can include a structure disposed on an occlusal surface of a dental appliance. An occlusal element of a dental appliance can include a surface shaped to interface with a portion of an opposing dental appliance and/or opposing dentition (e.g., a surface of an opposing dental appliance, an opposing occlusal surface of an opposing dental appliance, an occlusal surface of opposing dentition, etc.). An occlusal element can include a surface that, when engaged with a portion of an opposing dental appliance and/or opposing dentition, cause forces to be directed toward a person's mandible and/or maxilla so to cause repositioning of a person's mandible. In some implementations, repositioning of a person's mandible can include retraction along an anterior-posterior direction, advancement along an anterior-posterior direction, or some combination thereof. In various implementations, occlusal elements may have one or more features described in WO2021118975A1 to Sato et al, ‘Occlusal blocks for lateral locking,’ having filing number PCT/US2020/063743 and owned by Align Technology., which is hereby incorporated by reference as if set forth fully herein.

As used herein, the term occlusal element may include an occlusal block. As used herein, the term occlusal element may be an occlusal block.

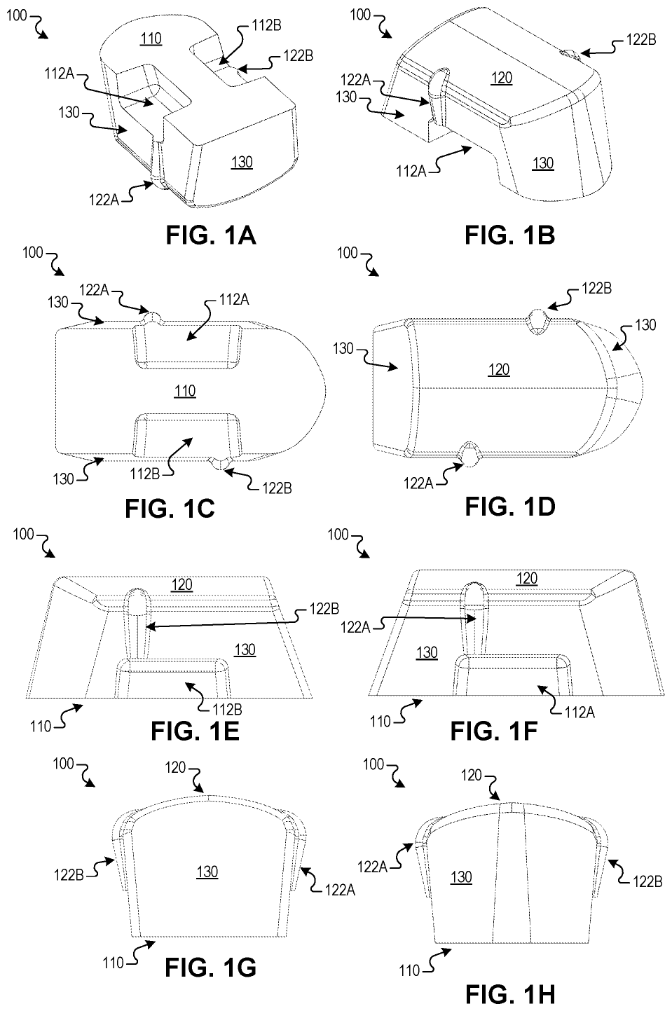

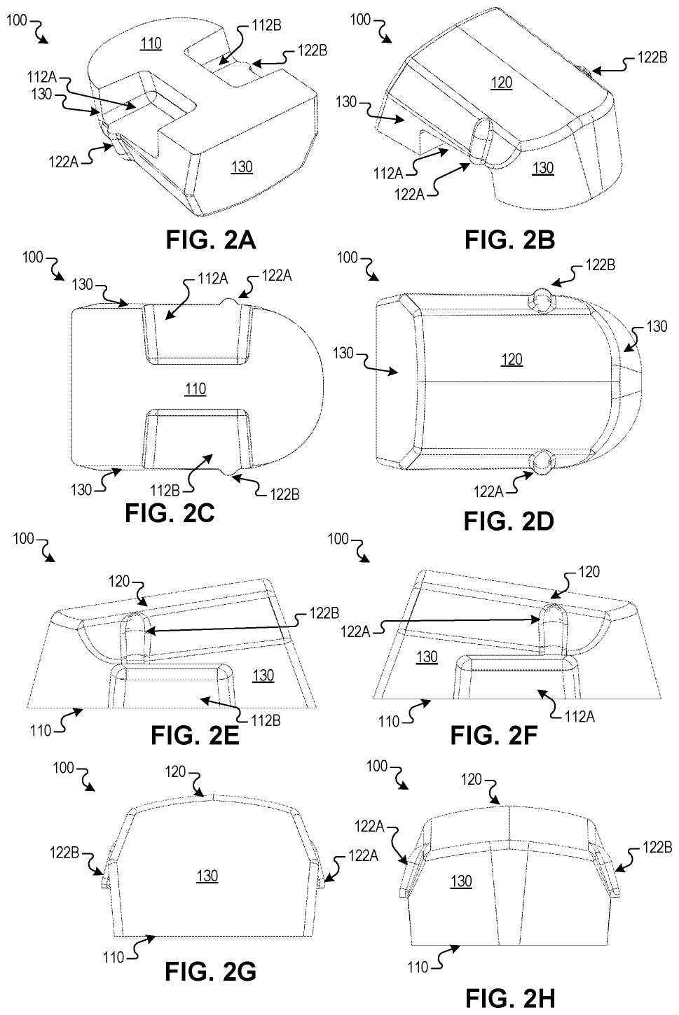

FIGS. 1A-H and 2A-H illustrate views of occlusal elements 100 (e.g., dental appliance occlusal elements, occlusal blocks, dental appliance occlusal blocks), according to certain embodiments. In some embodiments, each of FIGS. 1A-H illustrate the same occlusal element 100. In some embodiments, each of FIGS. 2A-H illustrate the same occlusal element 100. In some embodiments, the occlusal element 100 in FIGS. 1A-H is a lower element (e.g., configured to be press fit into a dental appliance for a lower jaw) and the occlusal element 100 in FIGS. 2A-H is an upper element (e.g., configured to be press fit into a dental appliance for an upper jaw).

FIGS. 1A and 2A illustrate bottom perspective views of occlusal elements 100. FIGS. 1B and 2B illustrate upper perspective views of occlusal elements 100. FIGS. 1C and 2C illustrate bottom views of occlusal elements 100. FIGS. 1D and 2D illustrate upper views of occlusal elements 100. FIGS. 1E-F and 2E-F illustrate side views of occlusal elements 100. FIGS. 1G and 2G illustrate rear views of occlusal elements 100. FIGS. 1H and 2H illustrate front views of occlusal elements 100.

Occlusal element 100 may be a dental appliance occlusal element. Occlusal element 100 may be solid (e.g., not hollow, not form an inner volume). Occlusal element 100 may include a lower surface 110, an upper surface 120, and one or more side surfaces 130.

Occlusal element 100 may be a feature of a dental appliance (e.g., aligner) configured to reposition the mandible (e.g., mandibular advancement, occlusal mandibular advancement feature, etc.) using elements on the occlusal surface of the teeth to interlock upper and lower dental appliances (e.g., aligners). Occlusal elements 100 may be used for repositioning or maintaining position of the mandible, which may include one or more of Class II correction, Class III correction, and/or obstructive sleep apnea correction appliances.

Dental appliances may be thermoformed over a mold, trimmed, and removed and then occlusal elements 100 may be inserted (e.g., in hollow features of dental appliances) and bonded to the dental appliance. Features of geometric shape (e.g., design features) of the occlusal elements 100 may address manufacturing requirements (e.g., improve manufacturability) and/or may improve the dental appliance compared to conventional solutions.

The lower surface 110 may include one or more features 112 configured to interface with a pick-and-place robot to cause the occlusal element 100 to be inserted into a hollow feature of a dental appliance. In some embodiments, feature 112 may be one or more of a notch, groove, recess, protrusion, etc. As shown in FIGS. 1A and 2A, lower surface 110 and/or side surfaces 130 may form features 112A-B that are recesses for a pick-and-place robot to grip the occlusal element 100 via the features 112A-B. In some embodiments, the one or more features 112 include notches for pick-and-place grippers.

In some embodiments, the one or more features 112 include a first recess and a second recess, where the pick-and-place robot includes a gripper including distal ends configured to secure the occlusal element 100 via the first recess and the second recess (e.g., by the first distal end being in a first recess and second distal end being in a second recess and the first distal end and the second distal end moving towards each other).

In some embodiments, the one or more features 112 include a channel, where the pick-and-place robot includes a gripper including distal ends configured to secure the occlusal element 100 via the channel (e.g., by the distal ends moving away from each other within the channel).

In some embodiments, the one or more features 112 include a substantially planar surface, where the pick-and-place robot includes a vacuum configured to secure the occlusal element 100 via suction of the substantially planar surface.

The upper surface 120 may be configured to be disposed adjacent a distal inner surface of a hollow feature of a dental appliance. In some embodiments, the upper surface is a curved surface.

The side surfaces 130 may be configured to be disposed against one or more side inner surfaces of the hollow feature of a dental appliance. In some embodiments, the one or more side surfaces comprise a lower side surface an upper side surface. In some embodiments, the upper side surface is a chamfer. In some embodiments, the lower side surface is from about 5 to about 9 degrees from vertical.

In some embodiments, the upper surface 120 and at least one of the one or more side surfaces 130 include an identifying feature 122 (e.g., element identifying features) configured to interface with a corresponding feature of the hollow feature of the dental appliance. Identifying features 122 may include one or more of recess, protrusion, element notch (e.g., for correct element identification), and/or the like.

As shown in FIGS. 1A and 2A, occlusal element 100 may include identifying feature 122A (e.g., protrusion from a first side surface 130) and identifying feature 122B (e.g., protrusion from a second side surface 130). The occlusal element 100 of FIG. 1A includes identifying feature 122A (e.g., protrusion) proximate rear side surface 130 and identifying feature 122B (e.g., protrusion) proximate front side surface 130. The occlusal element 100 of FIG. 2A includes identifying features 122A-B (e.g., protrusions) that are both proximate front side surface 130. The hollow feature of the lower dental appliance may form recesses that match the identifying features 122A-B of FIG. 1A and the hollow feature of the upper dental appliance may form recess that match the identifying features 122A-B of FIG. 2A. The identifying features 122A-B of occlusal element 100 of FIG. 1A may prevent occlusal element 100 of FIG. 1A from being inserted into the upper dental appliance. The identifying features 122A-B of occlusal element 100 of FIG. 2A may prevent occlusal element 100 of FIG. 2A from being inserted into the lower dental appliance. Different occlusal elements 100 (e.g., for upper jaw, for lower jaw, of different heights, etc.) may have different identifying features 122 to prevent the occlusal element 100 from being inserted in an incorrect location.

In some embodiments, notches (e.g., recesses) are added to the side surfaces 130 or lower surface 110 (e.g., base) of the occlusal elements 100 for robotic pick-and-place of occlusal elements 100 for automation of either occlusal element placement onto a mold or into a dental appliance (e.g., aligner). The pick-and-place robot (e.g., gripper) may have mating features (e.g., substantially match corresponding features on occlusal element 100) to prevent occlusal element 100 from falling off and to provide (e.g., assure) accurate positioning of the occlusal element 100.

In some embodiments, occlusal element 100 has element chamfers and base geometry for insertion (e.g., into dental appliance, onto mold).

To identify the type and/or size of occlusal element 100 (e.g., occlusal elements 100 for upper jaw or lower jaw, occlusal elements 100 for left side or right side, occlusal elements of different heights, etc.), identifying features 122 may be used on the occlusal element 100 and/or corresponding features may be used on the dental appliance (e.g., aligner) to be read by a vision system and/or manually (e.g., by a user, by a human quality control inspector). To identify occlusal elements 100, negative features such as grooves or notches, or raised features such as bumps or ridges, can be added to the occlusal element 100. Corresponding features in the dental appliance can be created as part of the mold (e.g., stereolithography (SLA) mold) and occlusal element 100 can be inserted into dental appliance after molding of the dental appliance. The identifying features 122 can also be used as poka-yokes (e.g., features that prevent errors, features that prevent incorrect insertion) to allow only occlusal elements 100 with matching identifying features 122 to be inserted into the hollow feature of the dental appliance (e.g., aligner cavity). In some embodiments, laser mark features can be added to the dental appliance to match with corresponding identifying features 122 of the occlusal elements 100. Size, quantity, and position of identifying features 122 can be used to create unique sets of identifying features 122 for each unique occlusal element 100 (e.g., or each unique type of occlusal element 100). Shape of the occlusal element 100 can also be used as identifying features 122, such as width, height, and length (e.g., different sized occlusal element 100 not fit into a hollow feature of dental appliance). In some embodiments, the features (e.g., identifying features 122) of the occlusal element 100 and dental appliance guide insertion of the occlusal element 100.

In some embodiments, chamfers are added to the top surface of the occlusal element 100 to guide the occlusal element 100 into the hollow feature of the dental appliance (e.g., aligner cavity) during press fit manufacturing. These chamfers, along with the top curved surface (e.g., upper surface 120), allow easier insertion into the dental appliance (e.g., aligner) and can provide haptic feedback (e.g., to the operator and/or when manually inserting elements). In some embodiments, the dental appliance can be fabricated with a wider entryway under the occlusal element 100 by adding a base feature under the occlusal element 100 as part of the SLA mold. Width, shape, and draft angle of the base of the occlusal element 100 can be modified to allow easier occlusal element insertion while also optimizing to minimize overlapping the tooth and attachment shapes (e.g., which can adversely affect aligner engagement with the teeth).

In some embodiments, the dental appliance has a base rim to secure the dental appliance in a holder during occlusal element insertion. In some embodiments, a rim, lip, and/or the like, around the base of the occlusal element 100 is used to help secure the dental appliance in the holder during occlusal element insertion. The rim of the base prevents the dental appliance from moving (e.g., slipping down) while the occlusal element is being inserted. Width of the base of the occlusal element 100 may be configured (e.g., optimized) to provide secure engagement while minimizing total base width to avoid excessive overlapping of tooth and attachment shapes (e.g., which can adversely affect dental appliance engagement with the teeth).

In some embodiments, each type of occlusal element 100 is shaped (e.g., based on identifying features 122, pattern of projections) for insertion into a cavity (e.g., formed by a hollow feature) of a type of dental of appliance. The identifying features 122 (e.g., pattern of projections) may identify the type of occlusal element 100. For example, occlusal element 100 of FIGS. 1A-H has a first pattern of identifying features 122 (e.g., first pattern of projections) that identifies a first type of occlusal element 100 and occlusal element 100 of FIGS. 2A-H has a second pattern of identifying features 122 (e.g., second pattern of projections) that identifies a second type of occlusal element 100.

In some embodiments, occlusal element 100 is a clear plastic (e.g., polymeric) object. In some embodiments, upper surface 120 of occlusal element 100 (e.g., that is to interface with an inner surface of a hollow feature of a dental appliance) is coated with a bonding agent (also referred to as a bonding layer) to facilitate a bond between the upper surface 120 of occlusal element 100 and the inner surface of the hollow feature of the dental appliance. In some embodiments, the bonding agent is a photo-thermal compound. One example of a photo-thermal compound that may be used is ClearWeld®. In some embodiments, plastics laser welding may be performed by directing coherent light having a target wavelength (e.g., in the infrared part of the spectrum) through the dental appliance and/or the occlusal element 100 onto an interface of the occlusal element 100 and the dental appliance. The photo thermal compound absorbs the light, and the coherent light causes the photo-thermal compound to heat up and melt the occlusal element 100 and the dental appliance at the interface of the occlusal element 100 and the dental appliance, which results in a weld between the occlusal element 100 and the dental appliance. Use of the photo thermal compound combined with laser welding results in no particulates, no vibration or surface marring, and strong, hermetic welds formed at high speed as compared to other bonding techniques such as adhesive bonding, solvent bonding, ultrasonic bonding, vibration bonding, and hot-plate weld bonding techniques. In some embodiments, any of these other bonding techniques may alternatively be used to bond the occlusal element 100 to the dental appliance. In some examples, the bonding layer is a thermally activated solvent and bonding is achieved by applying heat to activate the thermally activated solvent on the first surface. In some examples, the bonding layer is an ultraviolet cured adhesive and bonding is achieved by applying ultraviolet light to cure the ultraviolet cured adhesive on the upper surface 120.

In some embodiments, the upper surface 120 of the occlusal element 100 is a rough surface. The rough surface may improve a wettability (e.g., wetting) of the upper surface 120. The improved wettability of the upper surface 120 improves a uniformity of the photo thermal compound coated on the upper surface 120.

In some embodiments, side surfaces 130 of the occlusal element 100 are smooth surfaces. For example, in some embodiments lower surface 110 (e.g., opposite the upper surface 120) that will not contact the dental appliance has a lower average surface roughness than the upper surface 120. For example, the lower surface 110 opposite the upper surface 120 may be a smooth surface (e.g., a polished surface). The smooth surface may reduce at least one of absorbance or reflectance of the object to light.

In some embodiments, the occlusal element 100 includes plastic impregnated with a photo-thermal compound. For such embodiments, the dental appliance may be transparent or clear, and laser welding may be performed by directing coherent light through the dental appliance onto the upper surface 120 that is mated with the dental appliance. The photo-thermal compound at the upper surface 120 absorbs the coherent light having a target wavelength and generates heat that melts the occlusal element 100 and the dental appliance at the interface of the upper surface and the inner surface of the hollow feature. By impregnating the photo-thermal compound into the occlusal element 100, a manufacturing step of coating the occlusal element 100 with the photo-thermal compound may be eliminated.

In some embodiments, the occlusal element 100 incudes one or more through holes. The through holes may prevent air entrapment during placement of the occlusal element 100 into a cavity of a hollow feature of a dental appliance. Air entrapment may cause air bubbles that prevent successful bonding at a location of the air bubbles. In some embodiments, a vacuum is applied via the holes after the occlusal element 100 has been placed into a cavity of a dental appliance to remove any air. In some embodiments, the occlusal element 100 is shaped to prevent air entrapment (e.g., with a curved convex slope on upper surface 120 where the occlusal element 100 is to contact the hollow feature of the dental appliance).

In some embodiments, the occlusal element 100 is manufactured using injection molding. An injection mold may be formed, and an upper surface of the injection mold may be roughened to cause the upper surface 120 of the occlusal element 100 to have a target surface roughness. In some embodiments, the surface of the injection mold is roughened via chemical etching. In some embodiments, the upper surface 120 of the occlusal element 100 is coated with the bonding agent (e.g., photo-thermal compound) after the injection molding. In some embodiments, the bonding agent is sprayed onto the upper surface 120 of the occlusal element 100 (e.g., using ultrasonic spraying). An approximately uniform layer of the bonding agent may be achieved, facilitated by the upper surface 120 having a target wettability due to surface roughness of the upper surface 120.

In some embodiments, an ultrasonic spray system is utilized to apply a uniform coating of the adhesive agent. In some embodiments, the ultrasonic spray system includes an ultrasonic spray nozzle that breaks a liquid to be sprayed (e.g., using an ultrasonic frequency of about 120 kHz) into small droplets that evenly coat the upper surface 120 of the occlusal element 100. The spray may be shaped with airflow from an airflow system. The nozzle may be mounted to a gantry system, and the liquid delivery to the nozzle may be controlled by a syringe pump to control a flow rate. An amount of a photo-thermal compound that is deposited onto the occlusal element 100 may be controlled through varying gantry speed. Once deposited, the liquid may dry, leaving behind the coating of the photo thermal compound. One example of process parameters that achieve a uniform coating density of about 20 to about 60 nL/mm² (e.g., about 40 nL/mm²) include: 1) Line width (controlled by gantry height): about 15 mm; 2) Flow rate: about 0.250 mL/min; 3) Translation speed: about 27.8 mm/s; and/or 4) 4 passes with sufficient time between passes to allow coating to dry.

In some embodiments, occlusal elements 100 are placed into a tray, and are coated while in the tray. In some embodiments, occlusal elements 100 may be placed into the tray after being coated. In some embodiments, occlusal elements 100 may be placed onto a conveyor (e.g., a conveyor belt) before or after spraying the adhesive coating on the occlusal elements 100. In some embodiments, the occlusal elements 100 are placed on a tape and reel. The occlusal elements 100 may be located in object-shaped cavities in the tray. In some embodiments, a tray is double-sided to facilitate stacking for storage, shipping and/or loading of occlusal elements 100 into a welding station. In some embodiments, for loading of occlusal elements 100 into the welding station, a stack is inverted so that occlusal elements 100 have lower surface 110 (e.g., bottom (uncoated) faces that will not contact a dental appliance surface) accessible for pick-and-place by a robotic arm.

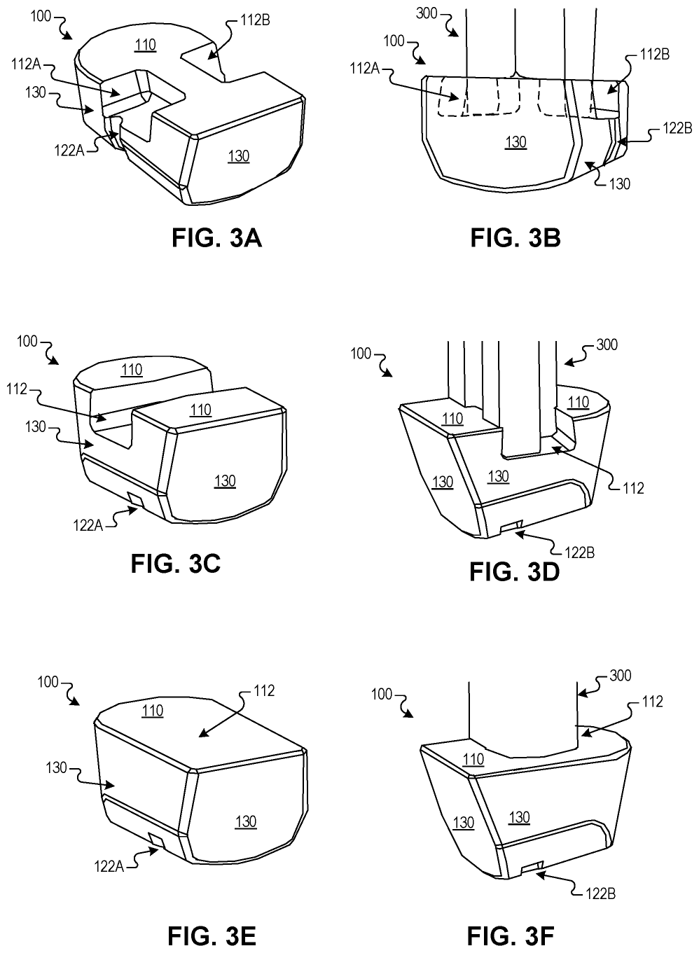

FIGS. 3A-F illustrate occlusal elements 100 (e.g., occlusal blocks, dental appliance occlusal blocks), according to certain embodiments.

FIGS. 3A-B illustrate an occlusal element 100 forming features 112 (e.g., recesses, notches) and FIG. 3B illustrates a gripper of a pick-and-place robot 300 bringing the distal ends of the gripper together to secure to occlusal element 100 via the features 112A-B to move occlusal element 100.

FIGS. 3C-D illustrate an occlusal element 100 forming feature 112 (e.g., recess, notch, channel) and FIG. 3D illustrates a gripper of a pick-and-place robot 300 moving the distal ends of the gripper apart to secure to occlusal element 100 via the feature 112 to move occlusal element 100.

FIGS. 3E-F illustrate an occlusal element 100 (e.g., occlusal block, dental appliance occlusal block) forming feature 112 (e.g., substantially planar surface) and FIG. 3F illustrates a vacuum component of a pick-and-place robot 300 securing to occlusal element 100 via suction of the feature 112 to move occlusal element 100.

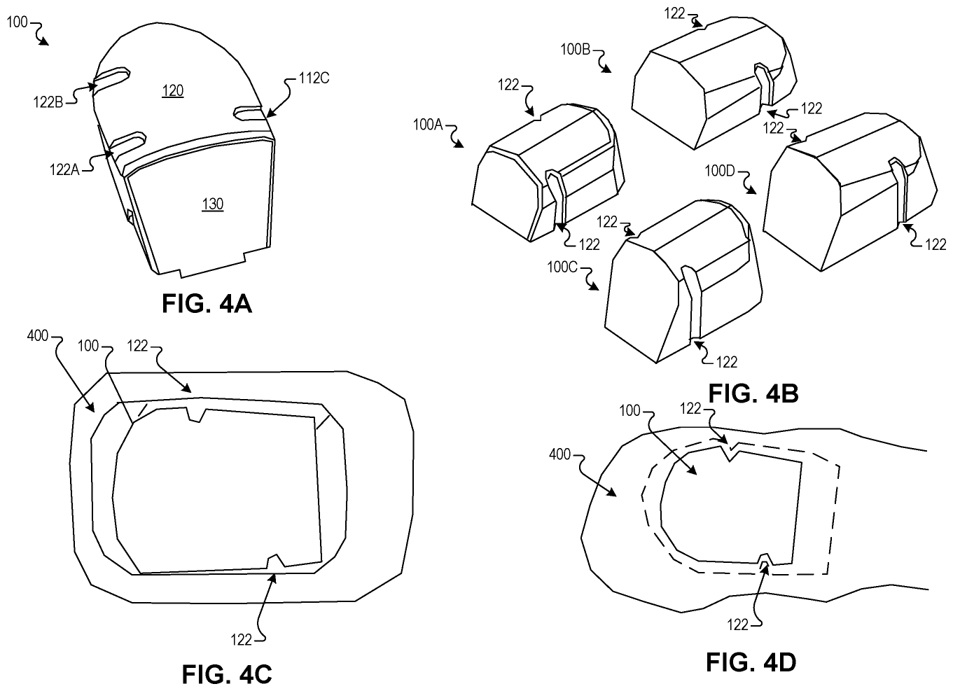

FIGS. 4A-D illustrate occlusal elements 100 (e.g., occlusal blocks, dental appliance occlusal blocks), according to certain embodiments.

Referring to FIG. 4A, occlusal element 100 may have multiple identifying features 122. In some embodiments, the identifying features 122 may be recesses (e.g., in upper surface 120 and/or side surfaces 130).

Referring to FIG. 4B, occlusal elements 100 may have different quantities and/or locations of identifying features 122 based on the type of occlusal element. For example, occlusal element 100A may be shorter and may be for a lower jaw, occlusal element 100B may be shorter and may be for an upper jaw, occlusal element 100C may be taller and may be for a lower jaw, and/or occlusal element 100D may be taller and may be for an upper jaw. Identifying features 122 of each of occlusal elements 100A-D may be different (e.g., both proximate a front side surface, both proximate a rear side surface, left proximate front side surface and right proximate rear side surface, left proximate rear side surface and right proximate front side surface, and/or the like).

Referring to FIG. 4C, the identifying features 122 of occlusal element 100 may substantially match the corresponding features of dental appliance 400.

Referring to FIG. 4D, the identifying features 122 of occlusal element 100 may not substantially match the corresponding features of dental appliance 400 (e.g., dental appliance 400 has three corresponding features and occlusal element 100 only includes two identifying features 122).

In some embodiments, a determination may be made (e.g., by a processing device, manually) whether the identifying features 122 match the corresponding features of the dental appliance 400. In some embodiments, the processing device obtains image data of the occlusal element 100 disposed in the dental appliance, provides the sensor data to a trained machine learning model (e.g., trained based on historical image data and historical performance data indicating whether the historical occlusal element 100 matches the historical dental appliance), receives output from the trained machine learning model, predicts whether the occlusal element 100 matches the dental appliance 400 based on the output data, and causes a corrective action (e.g., provide an alert, remove the occlusal element 100, insert the occlusal element in a different hollow feature, discard the dental appliance 400 and/or occlusal element 100, etc.) responsive to predicting the occlusal element 100 does not match the dental appliance 400.

In some embodiments, the occlusal element 100 may be bonded to the dental appliance 400 (e.g., to cause build lines to not be visible on the bottom surface of the occlusal element 100 that interfaces with the dental appliance 400). In some embodiments, the build limes are visible on the bottom of the occlusal element 100 prior to being bonded to the dental appliance 400.

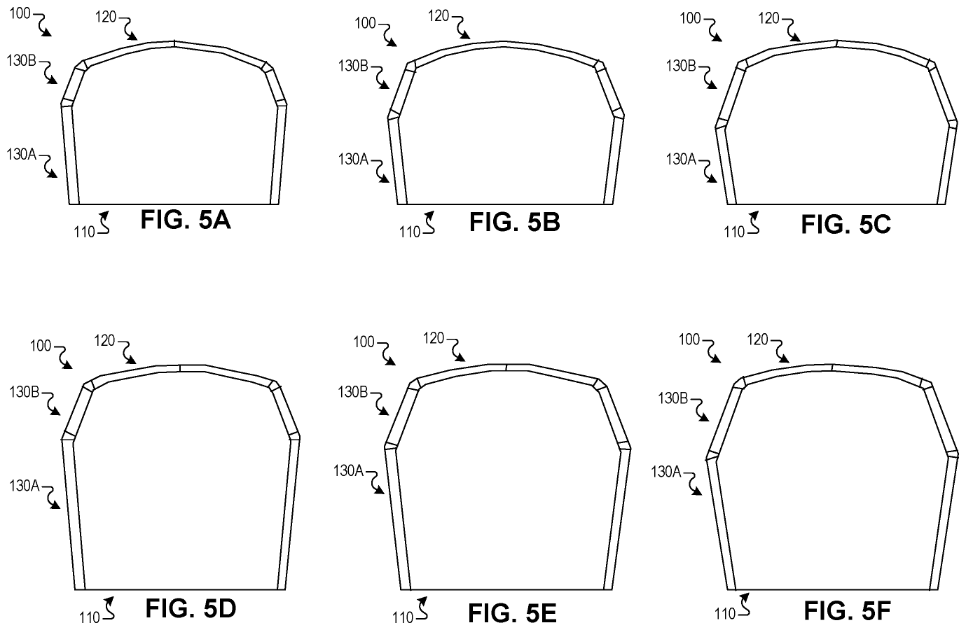

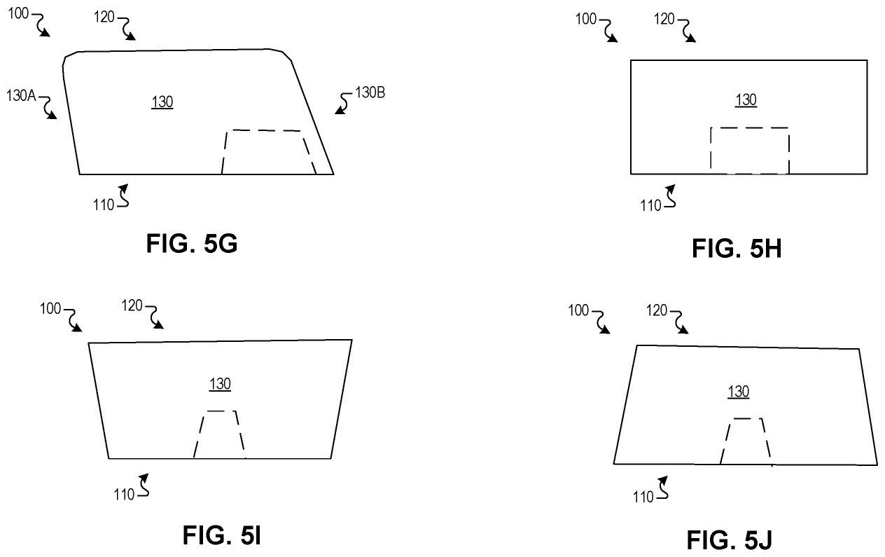

FIGS. 5A-I illustrate occlusal elements 100 (e.g., occlusal blocks, dental appliance occlusal blocks), according to certain embodiments.

Occlusal elements 100 of FIGS. 5A-C may be smaller and occlusal elements 100 of FIGS. 5D-5F may be taller. Occlusal elements 100 have side surfaces 130. Side surfaces 130 include a lower side surface 130A (e.g., between upper side surface 130B and lower surface 110) and an upper side surface 130B (e.g., between lower side surface 130A and upper surface 120). The lower side surface 130A may be about 5 degrees to about 9 degrees from vertical (e.g., so that the base width of occlusal element 100 is less than upper width of the occlusal element 100). FIGS. 5A and 5D illustrate about 5-degree angle between lower side surface 130A and the vertical. FIGS. 5B and 5E illustrate about 7-degree angle between lower side surface 130A and the vertical. FIGS. 5C and 5F illustrate about 9-degree angle between lower side surface 130A and the vertical. Upper side surface 130B may be a chamfer. At least a portion of lower side surface 130A may be substantially planar. At least a portion of upper side surface 130B may be substantially planar. Lower surface 110 may be substantially planar. Upper surface 120 may be substantially curved. In some embodiments, upper surface 120 may have about 0.5 to about 7 mm curvature (e.g., ellipsoid that has about 0.5 to about 5 millimeters minor axis). In some embodiments, occlusal element 100 is about 3 mm to about 7 mm in height.

FIGS. 5A-F illustrate occlusal elements 100 that have tapered side surfaces 130 where the upper surface 120 is wider than the lower surface 110.

FIGS. 5G illustrates an occlusal element 100 that has tapered side surfaces 130 where one has a positive taper (e.g., positive angle) and the other has a negative taper (e.g., negative angle). For example, side surface 130A extends from an upper surface 120 to a lower surface 110 where the upper surface 120 overhangs the lower surface 110. Side surface 130B extends from an upper surface 120 to a lower surface 110 where the lower surface 110 extends further out that the upper surface 120.

FIGS. 5H illustrates an occlusal element 100 that has a side surfaces 130 that are substantially perpendicular to the upper surface 120 and the lower surface 110 (e.g., occlusal element 100 is a substantially rectangular prism).

FIGS. 5I illustrates an occlusal element 100 that that has side surfaces 130A-B that are tapered from a wider upper surface 120 to a more narrow lower surface 110.

FIGS. 5J illustrates an occlusal element 100 that that has side surfaces 130A-B that are tapered from a wider lower surface 110 to a more narrow upper surface 120 (e.g., positive angles).

The occlusal elements (e.g., occlusal elements 110) of the present disclosure may have one or more of the side surfaces 130 as described in one or more of FIGS. 5A-J (e.g., negative angles).

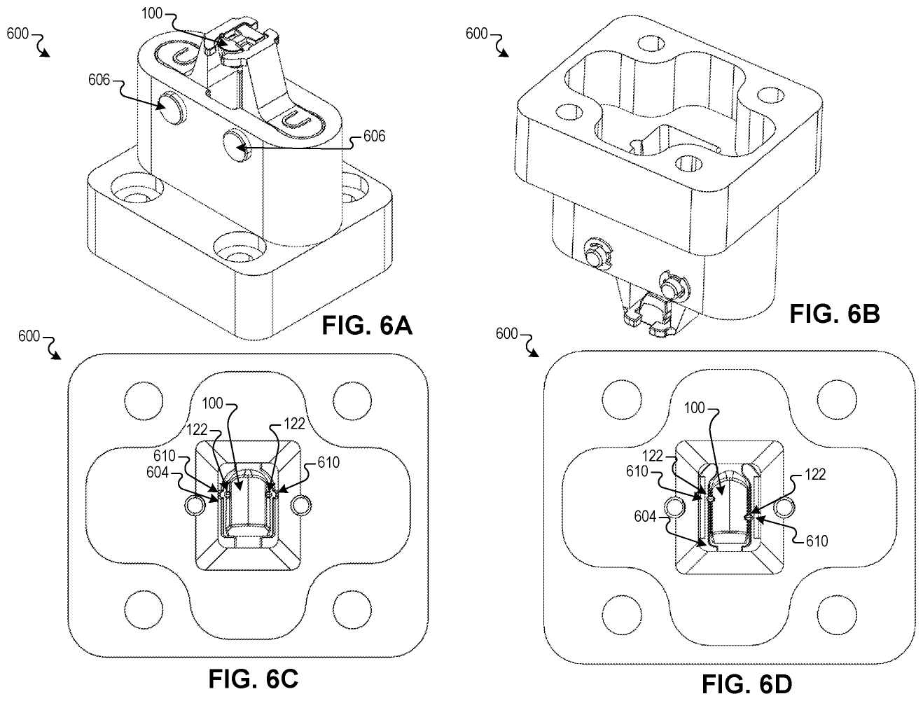

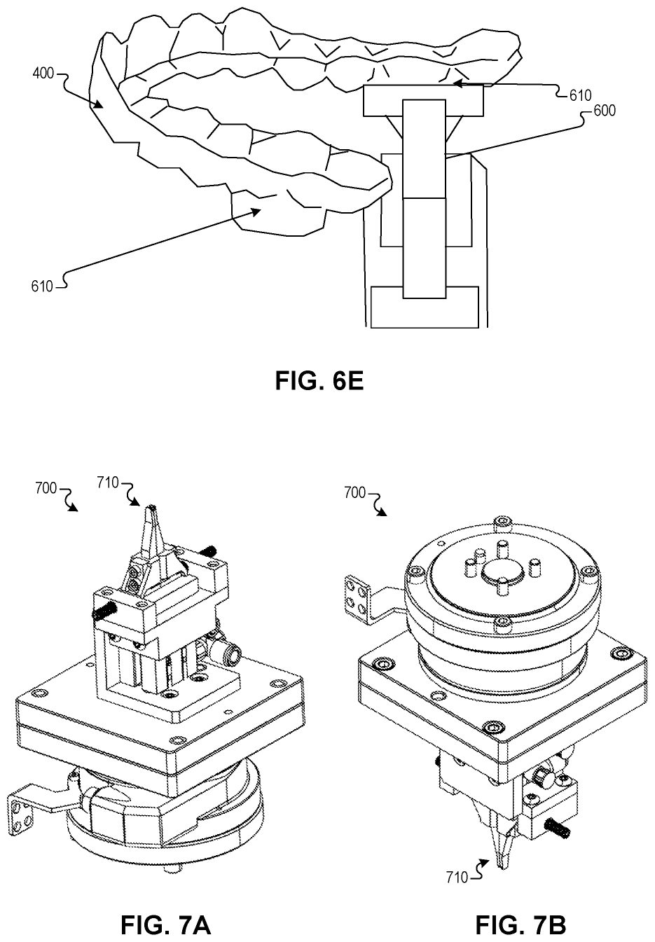

FIGS. 6A-E illustrate holders 600 associated with dental appliances, according to certain embodiments. Holder 600 may hold a type of occlusal element 100 (e.g., occlusal blocks, dental appliance occlusal blocks) and/or may secure a dental appliance 400. FIG. 6A illustrates an upper perspective view. FIG. 6B illustrates a lower perspective view. FIGS. 6C-D illustrate lower views of holders 600 for different types of occlusal elements 100 (e.g., different identifying features 122). FIG. 6E illustrates a perspective view of a holder 600 securing a dental appliance 400 (e.g., via hollow feature 410 of dental appliance 400).

In some embodiments, holder 600 includes jaws 602 that pivot about axes (e.g., provided by pins) 606. In some embodiments, each type of occlusal element 100 (e.g., identifying features 122) includes a notch and/or projection pattern that is unique to that type of occlusal element 100. In some embodiments, jaws 602 include a matching corresponding feature 610 (e.g., projection and/or notch pattern) that mates with the identifying feature 122 (e.g., notch and/or projection pattern) of the occlusal element 100. If the wrong type of occlusal element 100 is inserted into the holder 600, then the identifying features 122 (e.g., notch/projection pattern) fails to align with the corresponding feature 610 (e.g., projection/notch pattern) of the jaws 602. Occlusal element 100 may include a first identifying feature 122 (e.g., projection pattern) that matches a corresponding feature 610 (e.g., a first notch pattern) of jaws 602 of holder 600.

The holder 600 may be configured to receive features at a particular orientation. For example, occlusal element 100 and/or hollow feature 410 may have a first shape, size and/or angle on a first side and a second shape, size and/or angle on a second side. Jaws 602 of the holder 600 may be shaped to receive the feature having the first side with the first shape, size and/or angle and the second side with the second shape, size and/or angle in a set orientation. In some embodiments, the holder 600 will not receive the feature except in the correct orientation. In some embodiments, when the feature is correctly placed into the holder 600, a plane defined by the arch of the dental appliance 400 is approximately parallel to a plane defined by a surface on which the holder 600 is placed. If the feature is incorrectly placed into the holder 600, then the plane defined by the arch of the dental appliance 400 may not be parallel to the surface onto which the holder 600 is placed (e.g., a plane defined by a platform or table supporting the holder 600).

In some embodiments, holder 600 is a lower holder for holding dental appliances 400 that will be used on a lower dental arch or is an upper holder for holding dental appliances 400 that will be used on an upper dental arch. Holder 600 includes a pair of jaws 602. Each of jaws 602 pivot about a respective axis. The jaws 602 may be spring loaded such that a spring forces the jaws closed. A feature (e.g., occlusal element 100 and/or hollow feature 410 of dental appliance 400) for a dental arch may be inserted into the jaws 602. The jaws 602 may have a shape configured to receive and hold the feature. The jaws 602 may apply a sufficient clamping force to the feature to secure the feature (e.g., and the dental appliance 400 that includes the feature).

FIGS. 7A-B illustrate pick-and-place robot 700 (e.g., pick-and-place gripper), according to certain embodiments. Distal ends 710 of pick-and-place robot may interface with features 112 (e.g., recesses, channel, etc.) of occlusal element 100 (e.g., occlusal block, dental appliance occlusal block) to insert the occlusal element 100 in a hollow feature of a dental appliance 400.

Pick-and-place robot 700 may be a robot arm that is configured to pick occlusal elements 100 up (e.g., from tray) and insert the occlusal elements 100 into dental appliances 400 held in holders (e.g., holder 600). In some embodiments, the robot arm may be a multi-axis robot arm capable of movement in x, y and/or z axes and/or rotations about up to three axes. The robot arm may be programmed to pick an occlusal element 100 from a first known location and to place the occlusal element 100 at a hollow feature of a dental appliance at a second known location.

The robot arm may be programmed to apply a set force at particular positions (e.g., z coordinates) based on a type of object being placed. For example, during placement of the occlusal element 100 onto or into the hollow feature of the dental appliance, over a set robot arm z (vertical) position range an increased force may be used to insert the occlusal element 100 into a cavity of the hollow feature. In some embodiments, the cavity has a narrower opening along at least one dimension at a top of the cavity than at a bottom of the cavity. Accordingly, placing the occlusal element 100 against the hollow feature and into the cavity causes walls of the hollow feature to flex outward. An increased force may be applied by the robot arm to cause the walls of the hollow feature to flex outward over a particular z position range. Once the occlusal element 100 is fully seated against the hollow feature (e.g., pressed completely into a cavity of the hollow feature), the walls of the hollow feature may return to an unflexed position.

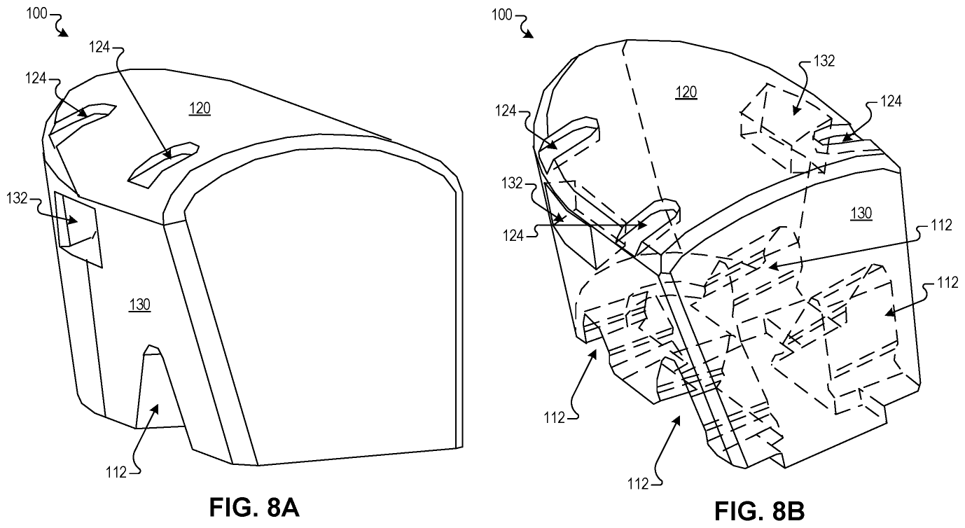

FIGS. 8A-B illustrate occlusal elements 100 (e.g., overmolding occlusal elements, occlusal blocks, dental appliance occlusal blocks, overmolding occlusal blocks), according to certain embodiments. In some embodiments, a dental appliance can be thermoformed on a dental mold including an occlusal element 100. In some embodiments, the occlusal element 100 is removably attached to the dental mold. In some embodiments, the occlusal element 100 is integral to the dental mold.

In some embodiments, the occlusal element 100 (e.g., overmolding occlusal element) includes an upper surface 120, one or more side surfaces 130, and a lower surface 110. In some embodiments, features of the geometric shape of the occlusal element 100 address manufacturing requirements (e.g., to enable repeatable assembly with the mold and/or dental appliances and allow (e.g., ensure) good fit and bonding to the dental appliance). An advantage of these features includes maximizing manufacturing throughput and successful assembly of the occlusal element 100 to dental appliances to allow scalable production of dental appliances (e.g., occlusal mandibular dental appliances).

The occlusal element 100 may be assembled with the dental appliance. In some embodiments, the occlusal element 100 is placed onto an SLA mold and the dental appliance is thermoformed over the mold with the occlusal elements 100 (e.g., overmolding) and then the dental appliance is trimmed and removed with the occlusal elements 100 retained inside the dental appliance. In some embodiments, the element shape of the occlusal elements 100 is created as part of the mold, the dental appliance is thermoformed over the mold, the dental appliance is trimmed and removed from the mold, and then the occlusal elements 100 (e.g., see FIGS. 1A-2H) are inserted (e.g., press fit) into the element cavity shape on the dental appliance.

The lower side surface 130A may form features 112 (e.g., notches and cutouts, poka-yoke features) configured to interface with corresponding features of a dental mold. A dental appliance is to be thermoformed over the dental mold and the occlusal element 100. The features 112 (e.g., various notches and cutouts) are used on the base of the occlusal elements 100 to mate the occlusal element 100 onto SLA mold during overmold thermofoming manufacturing process. The SLA mold is printed with the mating features and occlusal element 100 is inserted onto the mold to engage with the poka-yoke features. The size, position, and number of the features 112 (e.g., cutout features) are unique to the occlusal element 100 type and size (e.g., occlusal elements 100 for upper jaw or lower jaw; occlusal elements 100 for left side or right side; occlusal elements 100 with different heights, etc.). Additional features such as ribs and stepped bases can be added to occlusal element 100 to improve retention of the occlusal element 100 on the mold as well as add haptic feedback to allow operator to feel when occlusal element 100 is fully inserted onto the mold. Tolerancing can be tuned by changing the gap and rib prominence dimensions. Angled drafts are used to allow release of the occlusal element 100 and minimize mold breakage during dental appliance removal process. The occlusal element 100 may have poka-yoke features for retaining the occlusal element 100 on an SLA mold during overmolding (e.g., poka-yoke features allow correct occlusal element to be inserted on SLA mold and retains occlusal element during overmolding, e.g., thermoforming). The poka-yoke features may be used to mate the correct occlusal element 100 to the SLA mold.

In some embodiments, the upper surface 120 is curved. The occlusal element 100 may have a curved upper surface 120 for thermoforming (e.g., to improve thermoform quality on the upper surface 120 of the occlusal element 100). In some embodiments, the upper surface 120 forms one or more recesses 124 (e.g., and/or channels, openings, through-holes, etc. to remove air from between the upper surface 120 and the dental appliance for thermoforming).

Removal of the pocket of air may prevent burning of the dental appliance during laser marking of the dental appliance. By using a curved upper surface 120, or other methods of removing the air (grooves or channels on top surface) between occlusal element 100 and sheet of material during thermoforming, the present disclosure may provide improved contact between occlusal element 100 and dental appliance than conventional solutions. This may provide improved laser mark quality and improved bonding between dental appliance and occlusal element 100 than conventional solutions.

The one or more side surfaces 130 include an upper side surface and a lower side surface. The upper side surface is chamfered. The lower side surface is about 5 to about 9 degrees from vertical. The occlusal element 100 may have element chamfers and base geometry for insertion. In some embodiments, top corners (e.g., upper side surfaces) of the occlusal element 100 are chamfered and the base has wide features to allow easier insertion into the dental appliance.

In some embodiments, the features 112 of the lower side surface 130A include recesses formed by ribbed sidewalls. In some embodiments, the features include angled recesses.

In some embodiments, the lower surface 110 forms a stepped base configured to interface with the dental mold.

In some embodiments, the one or more side surfaces 130 form recesses 132 configured to interface with a pick-and-place robot to cause the occlusal element 100 to be secured to the dental mold (e.g., moved and placed against the dental mold via the pick-and-place robot). The occlusal element 100 may have recesses 132 (e.g., notches) for grippers of a pick-and-place robot. Recesses 132 (e.g., notches) on the side surface 130 or lower surface 110 are used for pick-and-place grippers for insertion on SLA mold or into dental appliance.

In some embodiments, the upper surface 120 and at least one of the one or more side surfaces 130 form a feature (e.g., protrusion, recess, etc.) configured to form a corresponding feature in the dental appliance to interface with an occlusal element (e.g., to interface with an identifying feature 122 of an occlusal element to be inserted into and bonded to the thermoformed dental appliance). The occlusal element 100 may have features 112 (e.g., element notches) for correct occlusal element 100 identification. In some embodiments, identifying features 122 (e.g., element notches, protrusions) on the upper surface 120 and/or side surfaces 130 are used for identifying correct occlusal element 100 and can be used as poka-yoke for correct occlusal element 100 insertion into the dental appliance.

In some embodiments, the one or more side surfaces 130 form a lip. The lip is about 0.5 millimeters (mm) to about 1.0 mm (e.g., in width). The occlusal element 100 may have a rim around the base for holder 600 of dental appliances. The rim may be disposed around the base to secure the dental appliance in holder 600 during occlusal element insertion.

In some embodiments, a dental appliance mold includes a dental arch portion associated with a current or future dental arch of a user and an occlusal element portion (e.g., occlusal element 100). The occlusal element 100 includes a curved upper surface 120 and one or more side surfaces 130 that form a lip that is about 0.5 mm to about 1.0 mm. A dental appliance is configured to be thermoformed over the dental appliance mold. A hollow feature of the dental appliance is to be formed over the occlusal element 100.

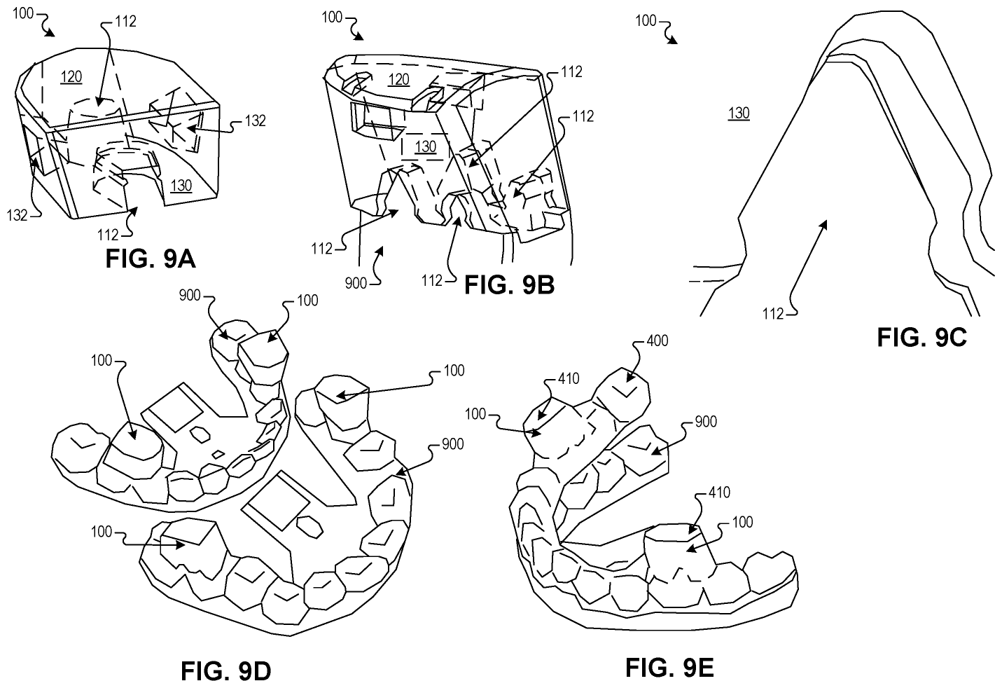

FIGS. 9A-E illustrate occlusal elements 100 (e.g., occlusal blocks, dental appliance occlusal blocks), according to certain embodiments.

Referring to FIG. 9A, lower surface 110 of occlusal element 100 may form one or more features 112 (e.g., recesses, notches, etc.). A feature 112 may include a rib. For example, side surface that form the feature may have a protrusion (e.g., rib protrudes away from the side surface that forms feature) or recess (e.g., rib is recessed into the side surface that forms feature).

Referring to FIG. 9B, lower surface 110 of occlusal element 100 may form one or more features 112 (e.g., recesses, notches, etc.) and/or a stepped base. The features 112 may be tapered (e.g., angled to a point) to guide the protrusions of the mold 900 into the features 112. The stepped base may overlap a portion of the mold 900.

Referring to FIG. 9C, a feature 112 formed by lower surface 110 of occlusal element 100 may be tapered. There may be a gap between the feature 112 and protrusion of mold 900. The feature 112 may have a rim that is configured to removably secure the occlusal element 100 to the mold 900.

Referring to FIG. 9D, occlusal elements 100 may be secured to molds 900. Mold 900 may be a 3D printed mold 200 of a dental arch of a patient. As shown, in some embodiments the mold 900 includes one or more features that extend beyond the patient's dentition represented in the mold 900. Such features may be, for example, occlusal elements 100 and/or jaw positioning features. The one or more features (referred to as non-native features) may not represent a patient's teeth. In some embodiments, the features (e.g., occlusal elements 100) may be added to a digital representation of the mold that is used by a rapid prototyping machine (e.g., a 3D printer) to print the mold 900, and the mold 900 may be fabricated to include the features (e.g., occlusal elements 100). In some embodiments, the mold 900 may be fabricated without the features (e.g., occlusal elements 100) and the features (e.g., occlusal elements 100) may be attached to the mold 900 after the mold 900 is manufactured. Many different types of features may be added. Features (e.g., occlusal elements 100) may have any imaginable shape, size, orientation, etc. that is appropriate for insertion into a patient's mouth. In some embodiments, the mold 900 may be fabricated with one or more registration features. In such embodiments the features (e.g., occlusal elements 100) may be attached to the mold via the registration features (e.g., features 112).

In some embodiments, the mold 900 includes a feature onto which the occlusal element 100 is placed. In some embodiments, the feature includes an engagement structure that helps to secure the occlusal element 100 to the feature of the mold 900. In some embodiments, the feature of the mold 900 is a dovetail pin, and the occlusal element 100 includes a dovetail channel that is shaped to receive the dovetail pin. Other types of engagement structures may also be used. A force may be applied to flex the surfaces of the feature of the mold 900 and/or the inner surfaces of the feature of the occlusal element 100. Once the occlusal element 100 is fully seated against the mold 900, then the surfaces of the mold 900 and/or occlusal element 100 may return to the unflexed position. In some embodiments, other types of engagement features may be used, such as other types of pins, flats, grooves, curves and/or indentations.

Referring to FIG. 9E, occlusal elements 100 may be secured in hollow features 410 of dental appliances 400. In some embodiments, the occlusal elements 100 may be retained in the hollow features 410 of dental appliance 400 responsive to thermoforming the dental appliance 400 over the mold 900. In some embodiments, the occlusal elements 100 may be inserted in the hollow features 410 of dental appliance 400 subsequent to thermoforming the dental appliance 400 over the mold 900.

In some embodiments, occlusal element 100 may be inserted into a hollow feature 410 of a dental appliance that has a narrower opening at a top of the hollow feature 410 than at a bottom of the hollow feature 410. Accordingly, the cavity formed by hollow feature 410 has a negative incline in at least one dimension. As shown, a width W2 of a bottom of the cavity is wider than a width W1 of a top of the cavity of the hollow feature 410 of dental appliance 400. Accordingly, when a bottom of the occlusal element 100 is pressed against the top of the hollow feature 410, the walls of the hollow feature 410 flex outward. Then once the occlusal element 100 is fully seated into the cavity formed by the hollow feature 410, the walls of the hollow feature 410 return to non-flexed positions.

Dental appliance 400 (e.g., orthodontic aligner) may be customized to reposition teeth of a patient for a stage of orthodontic treatment. The dental appliance 400 (e.g., orthodontic aligner) is a tooth and/or jaw repositioning appliance that can be worn by a patient to achieve an incremental repositioning of individual teeth in the jaw. The dental appliance 400 can include a shell (e.g., a translucent or clear polymeric shell) having teeth-receiving cavities (e.g., hollow features 410) that receive and resiliently reposition the teeth. In some embodiments, the mold 900 includes one or more features (e.g., hollow features 410) (referred to as non-native features) that extend beyond the patient's dentition represented in the dental appliance 400. The hollow features 410 correspond to features of mold 900 (e.g., occlusal elements 100). Such features may be, for example, occlusal elements 100 and/or jaw positioning features. The hollow features 410 may include large cavities that are susceptible to being crushed.

Dental appliance 400 is an example tooth repositioning appliance that can be worn by a patient in order to achieve an incremental repositioning of individual teeth in the jaw. The appliance can include a shell (e.g., a continuous polymeric shell or a segmented shell) having teeth-receiving cavities that receive and resiliently reposition the teeth. An aligner or portion(s) thereof may be indirectly fabricated using a physical model of teeth. For example, an appliance (e.g., polymeric appliance) can be formed using a physical model of teeth and a sheet of suitable layers of polymeric material. A “polymeric material,” as used herein, may include any material formed from a polymer. A “polymer,” as used herein, may refer to a molecule composed of repeating structural units connected by covalent chemical bonds often characterized by a substantial number of repeating units (e.g., equal or greater than 3 repeating units, optionally, in some embodiments equal to or greater than 10 repeating units, in some embodiments greater or equal to 30 repeating units) and a high molecular weight (e.g., greater than or equal to 10,000 Da, in some embodiments greater than or equal to 50,000 Da or greater than or equal to 100,000 Da). Polymers are commonly the polymerization product of one or more monomer precursors. The term polymer includes homopolymers, or polymers consisting essentially of a single repeating monomer subunit. The term polymer also includes copolymers which are formed when two or more different types of monomers are linked in the same polymer. Useful polymers include organic polymers or inorganic polymers that may be in amorphous, semi-amorphous, crystalline or semi-crystalline states. Polymers may include polyolefins, polyesters, polyacrylates, polymethacrylates, polystyrenes, polypropylenes, polyethylenes, polyethylene terephthalates, poly lactic acid, polyurethanes, epoxide polymers, polyethers, poly(vinyl chlorides), polysiloxanes, polycarbonates, polyamides, poly acrylonitriles, polybutadienes, poly(cycloolefins), and copolymers. The systems and/or methods provided herein are compatible with a range of plastics and/or polymers. Accordingly, this list is not inclusive, but rather is exemplary. The plastics can be thermosets or thermoplastics. The plastic may be thermoplastic.

Examples of materials applicable to the embodiments disclosed herein include, but are not limited to, those materials described in the following Provisional patent applications filed by Align Technology: “MULTIMATERIAL ALIGNERS,” U.S. Prov. App. Ser. No. 62/189,259, filed Jul. 7, 2015; “DIRECT FABRICATION OF ALIGNERS WITH INTERPROXIMAL FORCE COUPLING”, U.S. Prov. App. Ser. No. 62/189,263, filed Jul. 7, 2015; “DIRECT FABRICATION OF ORTHODONTIC APPLIANCES WITH VARIABLE PROPERTIES,” U.S. Prov. App. Ser. No. 62/189 291, filed Jul. 7, 2015; “DIRECT FABRICATION OF ALIGNERS FOR ARCH EXPANSION”, U.S. Prov. App. Ser. No. 62/189,271, filed Jul. 7, 2015; “DIRECT FABRICATION OF ATTACHMENT TEMPLATES WITH ADHESIVE,” U.S. Prov. App. Ser. No. 62/189,282, filed Jul. 7, 2015; “DIRECT FABRICATION CROSS-LINKING FOR PALATE EXPANSION AND OTHER APPLICATIONS”, U.S. Prov. App. Ser. No. 62/189,301, filed Jul. 7, 2015; “SYSTEMS, APPARATUSES AND METHODS FOR DENTAL APPLIANCES WITH INTEGRALLY FORMED FEATURES”, U.S. Prov. App. Ser. No. 62/189,312, filed Jul. 7, 2015; “DIRECT FABRICATION OF POWER ARMS”, U.S. Prov. App. Ser. No. 62/189,317, filed Jul. 7, 2015; “SYSTEMS, APPARATUSES AND METHODS FOR DRUG DELIVERY FROM DENTAL APPLIANCES WITH INTEGRALLY FORMED RESERVOIRS”, U.S. Prov. App. Ser. No. 62/189,303, filed Jul. 7, 2015; “DENTAL APPLIANCE HAVING ORNAMENTAL DESIGN”, U.S. Prov. App. Ser. No. 62/189,318, filed Jul. 7, 2015; “DENTAL MATERIALS USING THERMOSET POLYMERS,” U.S. Prov. App. Ser. No. 62/189,380, filed Jul. 7, 2015; “CURABLE COMPOSITION FOR USE IN A HIGH TEMPERATURE LITHOGRAPHY-BASED PHOTOPOLYMERIZATION PROCESS AND METHOD OF PRODUCING CROSSLINKED POLYMERS THEREFROM,” U.S. Prov. App. Ser. No. 62/667,354, filed May 4, 2018; “POLYMERIZABLE MONOMERS AND METHOD OF POLYMERIZING THE SAME,” U.S. Prov. App. Ser. No. 62/667,364, filed May 4, 2018; and any conversion applications thereof (including publications and issued patents), including any divisional, continuation, or continuation-in-part thereof.

The dental appliance 400 can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth (e.g., may include hollow features 410). In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance in place over the teeth. In some cases, however, it may be desirable or necessary to provide individual attachments or other anchoring elements on teeth with corresponding receptacles or apertures in the appliance so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

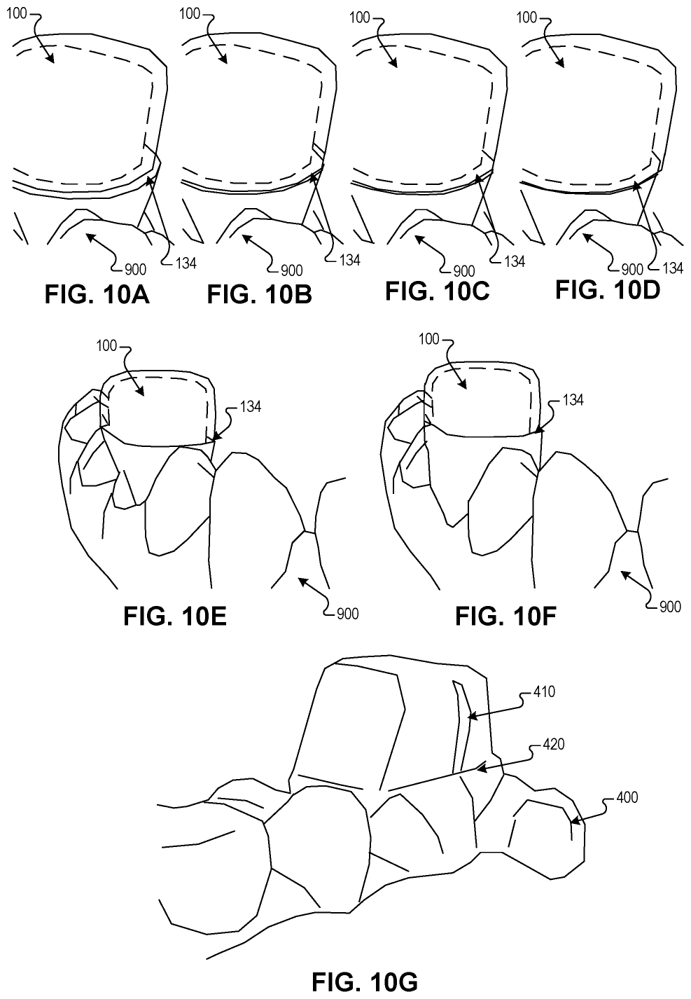

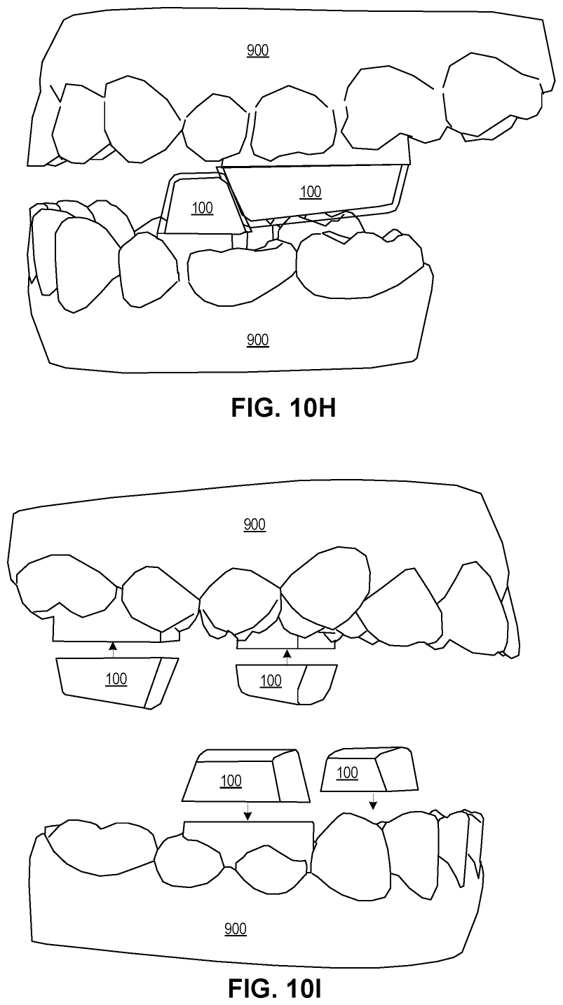

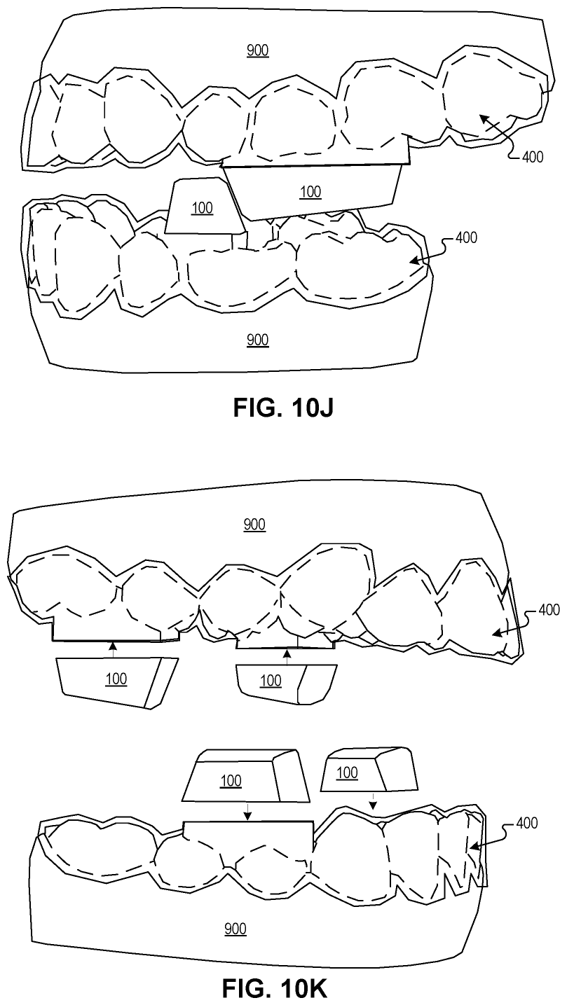

FIGS. 10A-K illustrate occlusal elements 100 (e.g., occlusal blocks, dental appliance occlusal blocks), according to certain embodiments. In some embodiments, occlusal elements 100 are integral to mold 900. In some embodiments, occlusal elements 100 are removably secured (e.g., via features 112 of lower surface 110 and protrusions of mold 900) to mold 900.

Referring to FIGS. 10A-F, side surface 130 of occlusal elements 100 may form a lip 134 that is about 0.5 to about 1.0 mm. Referring to FIGS. 10E-F, occlusal elements 100 may have different sizes of bases. Referring to FIG. 10G, the lip 134 may form a lip 420 on dental appliance 400 (e.g., proximate where hollow feature 410 and the rest of dental appliance 400 meet).

Referring to FIGS. 10H and 10J, in some embodiments a length of a first occlusal element 100 (e.g.,

occlusal element 100 associated with the upper dental arch) is increased and the length of a second occlusal element 100 (e.g., occlusal element 100 associated with the lower dental arch) opposite the first occlusal element is decreased. This may improve placement of the occlusal elements 100 over missing teeth of a dental arch of a patient. The longer occlusal element 100 may be placed to span missing teeth or the shorter occlusal element 100 may be placed to avoid placement over a missing tooth.

Referring to FIGS. 10H-I, in some embodiments, an occlusal element 100 is secured to the mold 900. The occlusal element 100 may be secured to a flat region of the mold 900. In some embodiments, a dental appliance 400 is overmolded on the occlusal elements 100. In some embodiments, hollow element features are created as part of a shape of a thermoformed dental appliance 400 (e.g., via molds including occlusal elements 100, see FIGS. 10H-I) and then pre-fabricated elements (e.g., occlusal elements 100) are inserted into the hollow element features (e.g., insertion of occlusal element 100 into a cavity of the dental appliance 400).

Referring to FIGS. 10J-K, in some embodiments, an occlusal element 100 is secured (e.g., welded, bonded, laser bonded, laser welded, etc.) to the dental appliance 400 (e.g., that is formed over a mold 900). The occlusal element 100 may be secured to a flat region (e.g., flat plane bonding surface) of the dental appliance 400 (e.g., welding/bonding occlusal element 100 to an exterior of the dental appliance 400). In some embodiments, a flat region is created as part of the shape of the thermoformed dental appliance 400 and then prefabricated elements (e.g., occlusal elements 100) are attached (e.g., welded, bonded, etc.) onto the exterior of the dental appliance 400 (e.g., and mate against features, attached to occlusal surface of the dental appliance 400). The features (e.g., protrusions, recesses) could have locating features for element alignment and mating (e.g., for aligning the occlusal element 100 on the dental appliance 400 and welding the occlusal element 100 in place). In some embodiments, the welding or bonding may be through the dental appliance 400 to secure the dental appliance 400 to the occlusal element 100 (e.g., after removing the dental appliance 400 from the mold 900). In some embodiments, the welding or bonding may be through the occlusal element 100 to secure the occlusal element 100 to the dental appliance 400 (e.g., prior to removing the dental appliance 400 from the mold 900).

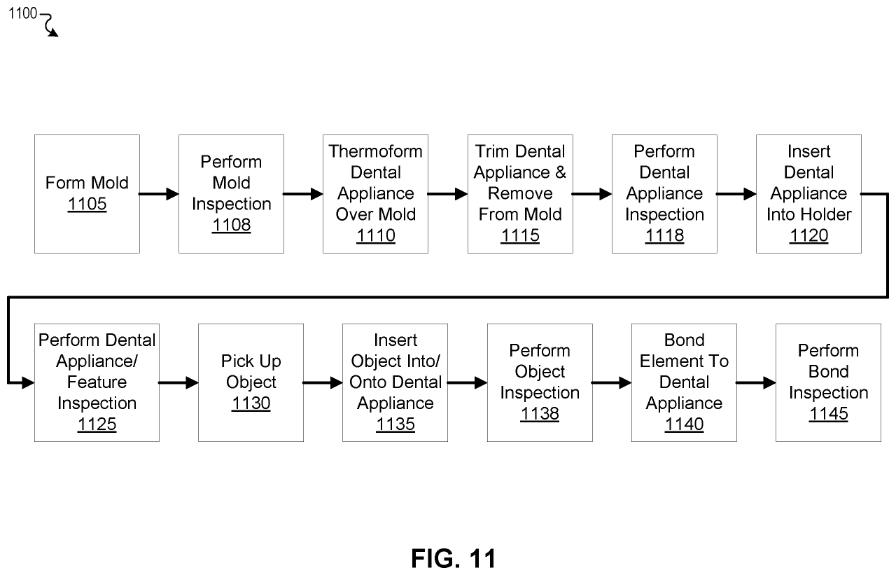

FIG. 11 illustrates a method 1100 associated with manufacturing a dental appliance using occlusal element 100 (e.g., occlusal block, dental appliance occlusal block), according to certain embodiments. Method 1100 may be a manufacturing sequence for manufacturing a dental appliance that includes one or more occlusal elements 100 bonded to the dental appliance.

At block 1105, the manufacturing sequence may begin with formation of a mold (e.g., mold 900 with an occlusal element 100). In embodiments, the mold may be formed using one or more rapid prototyping machines. In some embodiments, the mold may be a 3D printed object fabricated using additive manufacturing techniques (also referred to herein as “3D printing”). To manufacture the mold, a shape of the mold may be determined and designed using computer aided engineering (CAE) or computer aided design (CAD) programs. In some instances, stereolithography (SLA), also known as optical fabrication solid imaging, may be used to fabricate the mold. In SLA, the object is fabricated by successively printing thin layers of a photo-curable material (e.g., a polymeric resin) on top of one another. A platform rests in a bath of liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

In some embodiments, the mold may be produced using other additive manufacturing techniques. Other additive manufacturing techniques may include: (1) material jetting, in which material is jetted onto a build platform using either a continuous or drop on demand (DOD) approach; (2) binder jetting, in which alternating layers of a build material (e.g., a powder-based material) and a binding material (e.g., a liquid binder) are deposited by a print head; (3) fused deposition modeling (FDM), in which material is drawn through a nozzle, heated, and deposited layer by layer; (4) powder bed infusion, including but not limited to direct metal laser sintering (DMLS), electron beam melting (EBM), selective heat sintering (SHS), selective laser melting (SLM), and selective laser sintering (SLS); (5) sheet lamination, including but not limited to laminated object manufacturing (LOM) and ultrasonic additive manufacturing (UAM); and (6) directed energy deposition, including but not limited to laser engineering net shaping, directed light fabrication, direct metal deposition, and 3D laser cladding.

The mold formed at block 1105 may have the shape of a patient's dental arch and an aligner or other dental appliance may be formed over the mold. To manufacture the mold, a shape of the dental arch for the patient at a treatment stage may be determined based on a custom treatment plan. In the example of orthodontics, the treatment plan may be generated based on an intraoral scan of a dental arch to be modeled. The intraoral scan may be performed to generate a 3D virtual model of the patient's dental arch. In some instances, SLA techniques may be used to fabricate the mold of the patient's dental arch in accordance with the description above. A separate mold of the dental arch may be manufactured for each treatment stage of the patient.

Mold may include an occlusal element 100. In some embodiments, occlusal element 100 may be integral to the mold. In some embodiments, the occlusal element 100 may be removably secured to the mold.

At block 1108, the mold may optionally be inspected for defects. If the mold contains defects within its internal volume, on its surface, or on its interface, those defects may be transferred to a later formed aligner or other dental appliance formed using the mold. For example, a gap may exist between one or more thin layers of the mold as a result of a malfunction of the mold manufacturing process, causing air to become trapped within that gap. When vacuum is applied to remove trapped air during aligner manufacture, the air trapped in the gap between the thin layers of the mold may be removed and the thin layers may be forced together, closing the gap when pressure is applied to the plastic sheet. This type of defect is referred to herein as an “internal volume defect.” Internal volume defects may cause a deformation of the mold of the patient's dental arch during thermoforming of the aligner, which may be transferred to the aligner formed over the deformed mold. In another example, particles (e.g., debris), may form or collect on the surface of the mold. The shape of the particles may transfer to the aligner during the thermoforming process. This type of defect is referred to herein as a “surface defect.” In a further example, holes (e.g., pits) may form at the interface of the internal volume and the surface of the mold. The shape of the holes may transfer to the aligner during the thermoforming process. This type of defect is referred to herein as an “interface defect.” Collectively these defects may be referred to as layering defects.

Inspection of the mold may include generating one or more images of the mold and processing the one or more images using image processing and/or a one or more trained machine learning models that has been trained to perform quality analysis of 3D printed molds. In one embodiment, the mold inspection is performed according to U.S. patent application Ser. No. 16/685,848, filed Nov. 15, 2019, which is incorporated by reference herein. For example, a mold defect detection system may include an imaging system and a computing device. The imaging system may include a platform apparatus, a top view camera apparatus, and/or a side view camera apparatus. The computing device may include an imager control module, which may send instructions to the platform apparatus, top view camera apparatus and/or side view camera apparatus to cause the defect detection system to capture images of one or more regions of the mold disposed on the platform apparatus. The captured images may be sent to the computing device, and an image inspection module on the computing device may analyze the images of the mold to determine whether any manufacturing defects (e.g., gross defects, layering defects, etc.) are present in the mold. If the mold passes inspection, then the process may proceed to block 1110.

At block 1110, the orthodontic aligner or other dental appliance is formed (e.g., thermoformed) over the mold and occlusal element 100. In some embodiments, a sheet of material (e.g., a polymeric or plastic sheet) is pressure formed or thermoformed over the mold. To thermoform the dental appliance over the mold and occlusal element 100, the sheet of material may be heated to a temperature at which the sheet becomes pliable. Pressure may concurrently be applied to the sheet to form the now pliable sheet around the mold and occlusal element 100. In some embodiments, vacuum is applied to remove trapped air and pull the sheet onto the mold and occlusal element 100 along with pressurized air to form the sheet to the detailed shape of the mold. Once the sheet cools, it will have a shape that conforms to the mold and occlusal element 100.

At block 1115, the dental appliance (e.g., aligner) may be trimmed. The dental appliance may be trimmed along a cut line (e.g., a gingival cut line) in embodiments. The cut line may be specified in a digital file. A laser cutter may read the digital file to automatically cut the dental appliance along the cut line. Alternatively, the dental appliance may be manually cut along the cut line by a technician. The aligner may then be removed from the mold. Alternatively, the dental appliance may be removed from the mold prior to being trimmed.

At block 1118, inspection is performed of the dental appliance. The dental appliance may have defects caused by the thermoforming process, by the trimming process, and/or by removal of the dental appliance from the mold after the thermoforming process. Such defects may include, for example, a deformation, a bend, an improper cutline, and so on. Inspection of the dental appliance may include generating one or more images of the dental appliance and processing the one or more images using image processing and/or a one or more trained machine learning models that has been trained to perform quality analysis of thermoformed dental appliances. In one embodiment, the dental appliance inspection is performed according to U.S. patent application Ser. No. 16/145,016, filed Oct. 17, 2018, which is incorporated by reference herein. For example, a dental appliance defect detection system may include an imaging system and a computing device. The imaging system may include a platform apparatus, a top view camera apparatus, and/or a side view camera apparatus. The computing device may include an imager control module, which may send instructions to the platform apparatus, top view camera apparatus and/or side view camera apparatus to cause the defect detection system to capture images of one or more regions of the dental appliance disposed on the platform apparatus. The captured images may be sent to the computing device, and an image inspection module on the computing device may analyze the images of the dental appliance to determine whether any defects are present in the dental appliance. If the dental appliance passes inspection, then the process may proceed to block 1120.

At block 1120 the dental appliance is inserted into a holder (e.g., holder 600). The holder may be a specially designed holder that is configured to grasp one or more features (e.g., occlusal elements 100, hollow features 410) having specific shapes. In some embodiments, the holder may be a universal holder that can hold multiple features (e.g., occlusal elements 100, hollow features 410) having different shapes. In some embodiments, different holders are configured for holding different types of features (e.g., occlusal elements 100, hollow features 410). For example, a first holder may be configured to hold features (e.g., occlusal elements 100) having a first shape that are used for upper dental arches, and a second holder may be configured to hold features (e.g., occlusal elements 100) having a second shape that are used for lower dental arches.

At block 1125, aligner inspection and/or feature inspection is performed on the dental appliance in the holder. In one embodiment, the holder and held dental appliance are moved to an inspection station. In one embodiment, the holder and held dental appliance are automatically moved to the inspection station, such as via a conveyor (e.g., a conveyor belt). The holder with the dental appliance may be positioned at an inspection station when the dental appliance is inserted into the holder. Alternatively, the holder with the dental appliance may be moved to an inspection station after the dental appliance has been inserted into the holder.

In some embodiments, the inspection station includes one or more camera that generates one or more images of the dental appliance in the holder. The image or images may be processed to determine whether the dental appliance was properly inserted into the holder. This may include inputting the image or images into a trained machine learning model trained to determine whether the dental appliance has a proper placement in the holder. Additionally, or alternatively, the image or images may be processed to determine a dental appliance type (e.g., aligner type) for the dental appliance that has been inserted into the holder. Dental appliance types may include, for example, a dental appliance for an upper dental arch or a dental appliance for a lower dental arch. Dental appliance type may alternatively include a dental appliance with short occlusal elements for an upper dental arch, a dental appliance with tall occlusal elements for the upper dental arch, a dental appliance with short occlusal elements for the lower dental arch, or a dental appliance with tall occlusal elements for the lower dental arch. In one embodiment, the image or images are input into a trained machine learning model that outputs an identity of the dental appliance.

In some embodiments, processing logic may determine an object type for an object to be placed against a feature of the dental appliance (e.g., inserted into a cavity of a feature of the dental appliance). Each object type may have a different shape in embodiments. Each dental appliance type may include features that are shaped to receive a particular object type having a particular shape. In one embodiment, the object type is determined based on the dental appliance type determined at block 1125. In one embodiment, the feature of each dental appliance includes a pattern of notches and/or projections that unique to that type of dental appliance. Image processing and/or machine learning may have been performed at block 1125 to determine the dental appliance type, and an object type may then be determined that corresponds to the dental appliance type.

After inspection of the dental appliance, the holder and dental appliance may be moved to a robot station. In one embodiment, the holder and held dental appliance are automatically moved to the robot station, such as via a conveyor (e.g., a conveyor belt). Alternatively, the robot station may be collocated with the inspection station, and the holder is not moved after inspection at the inspection station.

At block 1130 a robot arm picks up an object (e.g., occlusal elements 100) having the determined object type.

At block 1135 the robot arm then places the object (e.g., occlusal elements 100) against the feature (e.g., hollow feature 410) of the dental appliance. This may include inserting the object into or onto the feature of the dental appliance, for example. The holder (e.g., holder 600) may hold the feature of the dental appliance at a reference position and with a known orientation. The robot arm may therefore automatically place the object at a correct position and orientation onto the feature of the dental appliance without the use of any cameras to determine how to position the robot arm relative to the dental appliance.

After the object has been placed into the dental appliance, the holder with the attached dental appliance may be moved to an inspection station. In one embodiment, the holder and held dental appliance are automatically moved to the inspection station, such as via a conveyor (e.g., a conveyor belt). In some embodiments, the dental appliance is moved to a same inspection station that was used to inspect the dental appliance in the holder prior to insertion of the object. In some embodiments, the inspection station may be different from the inspection station used to inspect the dental appliance in the holder. In some embodiments, the robot station corresponds to the inspection station.

At block 1138, inspection of the object inserted into the feature of the dental appliance may be performed. Inspection may include generating one or more images of the object placed against the feature (e.g., into a cavity of the feature) and processing the one or more images to determine whether the object was correctly placed against the feature of the dental appliance. In one embodiment, the image(s) is input into a trained machine learning model that outputs an indication as to whether the object was successfully placed against the feature. For example, processing logic may identify if the object is protruding from a cavity, or if the cavity walls remain flexed, or if the object is a wrong object type for the dental appliance, or if the object was inserted into the cavity with an incorrect orientation, and so on. For example, different sides of the feature may have different shapes, and a correct object may have sides with similar matching shapes to those of the feature. If an incorrect object is placed against the feature, or if a correct object is placed against the feature with an incorrect orientation, then the object may not properly mate with the feature. An image may show the incorrect mating of the object with the feature. If the object was incorrectly placed, then the object may be removed and/or replaced, and inspection may be repeated. Alternatively, the operation of block 1138 may be skipped, and the dental appliance and holder may be moved directly to a bonding station (e.g., a welding station). The machine learning model or a different machine learning model may also output an indication as to whether the dental appliance was damaged as a result of placing the object against the dental appliance. Damage detection may be performed using the same process or a similar process to that performed at block 1118.

At block 1140, the holder and held dental appliance are moved to the bonding station (e.g., welding station). In some embodiments, the holder and held dental appliance are automatically moved to the bonding station, such as via a conveyor (e.g., a conveyor belt). At the bonding station, a force may be applied to press the object (e.g., occlusal element 100) against the feature (e.g., hollow feature 410) of the dental appliance, and a bonding operation may be performed to bond the object (e.g., occlusal element 100) to the dental appliance. In some embodiments, a laser welding process is performed to weld the object (e.g., occlusal element 100) to the dental appliance.

After the object has been bonded to the dental appliance, the holder with the attached dental appliance may be moved to an inspection station in order for a bond inspection to be performed. In one embodiment, the holder and held dental appliance are automatically moved to the inspection station, such as via a conveyor (e.g., a conveyor belt). In one embodiment, the dental appliance is moved to a same inspection station that was used to inspect the dental appliance in the holder prior to insertion of the object and/or the inspection station that was used to inspect the dental appliance after the object was inserted into the dental appliance. Alternatively, the inspection station may be different from the previously used inspection stations. In one embodiment, the bonding station includes an integrated inspection station, and a bond inspection may be performed at the bonding station.

At block 1145, a bond inspection is performed at the inspection station. Performing the bond inspection may include capturing one or more images of the object attached to the dental appliance and performing image processing on the one or more images and/or inputting the one or more images into a trained machine learning model. The trained machine learning model and/or image processing algorithm(s) may output an indication of a bond quality. In an example, the dental appliance and/or the object may include build lines that remain present if an adequate bond has not been formed at a region. However, the build lines may melt and reflow when a proper bond is achieved, eliminating the build lines. Thus, processing logic may identify which regions retain build lines, and determine that those regions that retain build lines have not been successfully bonded. In one embodiment, a grid pattern is overlaid over the image of the object in the dental appliance. The grid pattern can be used to divide the interface between the object and the dental appliance into successful bond regions and unsuccessful bond regions. A size of the successful and/or unsuccessful bond regions may be determined and/or a ratio of the size of the successful bond region to the size of the unsuccessful bond region may be determined. The determined size(s) and/or ratio may be compared to one or more threshold to determine whether or not the bond meets one or more bond quality criteria. For example, if the successful bond region size is below a threshold, if the unsuccessful bond region size is above a threshold and/or if the ratio of the successful bond region size to the unsuccessful bond region size is below a threshold, then a determination may be made that the bond does not meet the quality criteria and is a partial weld. However, if the successful bond region size is at or above a threshold, if the unsuccessful bond region size is at or below a threshold and/or if the ratio of the successful bond region size to the unsuccessful bond region size is at or above a threshold, then a determination may be made that the bond meets the quality criteria. In one embodiment, the bond is considered a partial bond if less than 100% of the surface region has been bonded. In one embodiment, the bond is considered a partial bond if less than 80% of the surface region has been bonded. In one embodiment, the bond is considered a partial bond if less than 50% of the surface region has been bonded.

If the bond does not meet the quality criteria, then the bonding process may be repeated. After the bonding process has been repeated, another bond inspection may be performed at the inspection station. If after a threshold number of bond attempts the bond continues to not satisfy bond quality criteria, then the dental appliance may be scrapped. If the bond is successful, then the dental appliance is safe to use and can be packaged and shipped to a doctor or patient.

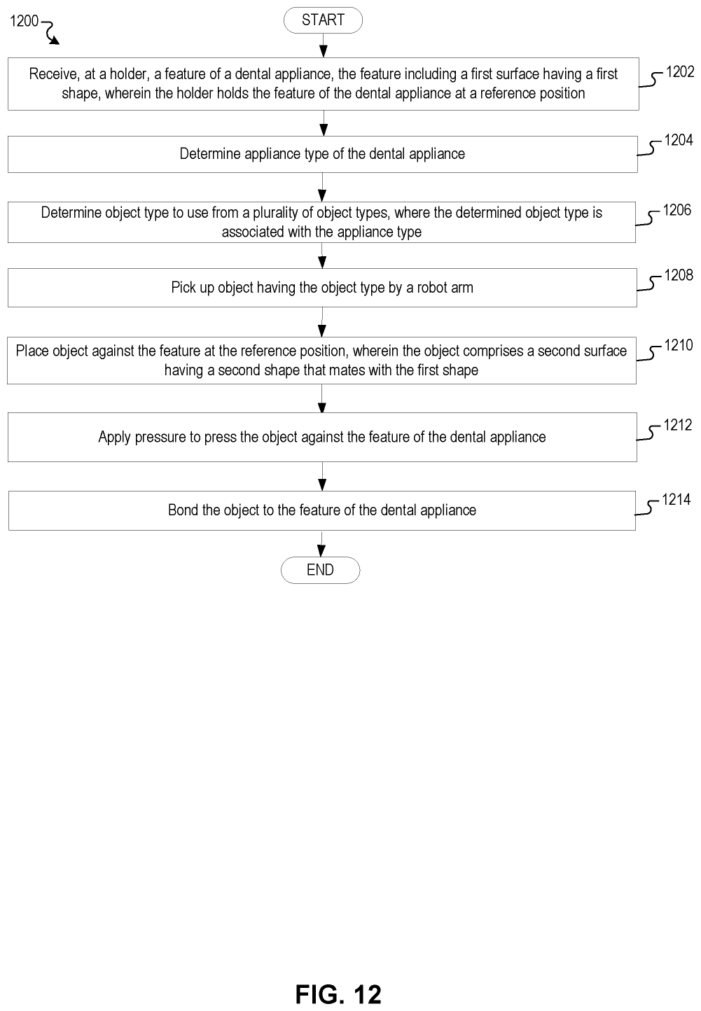

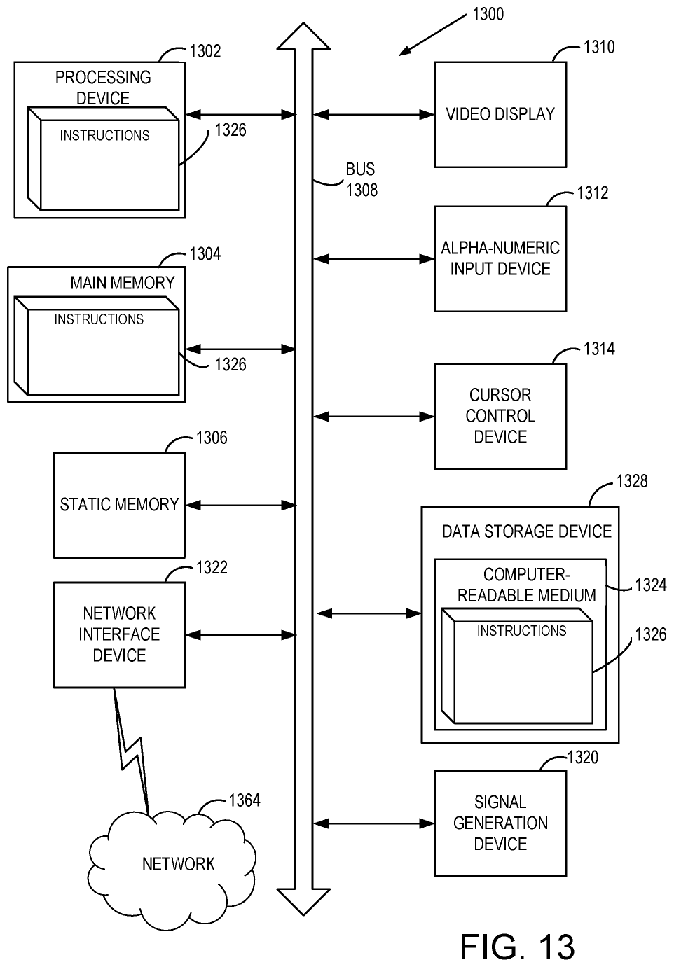

FIG. 12 illustrates a flow diagram for a method 1200 of manufacturing a dental appliance, according to certain embodiments. Some operations of the method 1200 may be performed by a processing logic that may comprise hardware (e.g., circuitry, dedicated logic, programmable logic, microcode, etc.), software (e.g., instructions run on a processing device to perform hardware simulation), or a combination thereof. The processing logic may execute on one or many processing devices (e.g., of computing device 1300 of FIG. 13). Some operations of method 1200 may be performed by a manufacturing system, which may include multiple inspection stations, a robot station and a bonding station in embodiments.

For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

At block 1202 of method 1200, the manufacturing system receives, at a holder, a feature (e.g., occlusal element 100, occlusal block, dental appliance occlusal block) of a dental appliance. The feature may include a first surface having a first shape. The holder may hold the feature (e.g., occlusal element 100) of the dental appliance at a reference position.

In some embodiments, an inspection station of the manufacturing system generates an image of the dental appliance in the holder, and processing logic processes the image to determine whether the appliance is correctly placed into the holder. In some embodiments, dental appliance placement assessor determines whether the dental appliance is properly placed in the holder based on processing of the image. If the dental appliance is correctly placed in the holder, the method continues to block 1204. In some embodiments, the dental appliance is repositioned in the holder or in a different holder.

At block 1204, processing logic determines an appliance type of the dental appliance. In some embodiments, the image of the dental appliance in the holder is processed by processing logic to determine the appliance type. In some embodiments, object type selector determines the appliance type from the image.

At block 1206, processing logic may determine an object type to use from a plurality of object types, where the determined object type is associated with the dental appliance type. In some embodiments, object type selector determines the object type.

At block 1208, an object having the determined object type is picked up by a robot arm at a robot station.

At block 1210, the robot arm places the object (e.g., occlusal element 100) against the feature (e.g., hollow feature 410) at the reference position. The object may have a second surface with a second shape (e.g., identifying feature 122) that mates with the first shape of the feature.

In some embodiments, processing logic determines whether the object was correctly placed against the feature of the dental appliance. In some embodiments, an inspection station generates an image of the object in the dental appliance and determined based on the image whether the object was correctly placed into or onto the feature of the dental appliance. In some embodiments, object placement assessor determines whether the object was correctly placed against the feature of the dental appliance. If the object was not correctly placed against the feature of the dental appliance, the robot arm may remove the object from the dental appliance and/or reposition the object against the feature of the dental appliance.

In some embodiments, processing logic processes the image of the object placed into or onto the feature to determine whether the dental appliance has been damaged during the manufacturing process (e.g., due to the placement of the object against the dental appliance). If the dental appliance has been damaged, the dental appliance may be scrapped. Processing logic may then mark or label the dental appliance for disposal in an inventory tracking database. If the dental appliance has not been damaged, then the method may proceed to block 1212.

At block 1212, processing logic applies pressure to press the object (e.g., occlusal element 100) against the feature (e.g., hollow feature 410) of the dental appliance at a bonding station.

At block 1214, the feature (e.g., occlusal element 100) is bonded to the dental appliance (e.g., via laser welding).

In some embodiments, processing logic determines one or more properties of the bond. This may include generating an image of the bond (e.g., at an inspection station) and processing the image using processing logic. In one embodiment, the image is processed by bond assessor, which outputs the one or more properties of the bond. In some embodiments, processing logic determines whether the properties of the bond satisfy one or more bond quality criteria. If the properties of the bond fail to satisfy one or more bond quality criteria, then the bond process may be repeated. If at determination is made that the bond satisfies the one or more bond quality criteria, the processing logic may determine that the dental appliance is ready for packaging and shipment to a doctor or patient. The dental appliance may be marked or tagged for shipment in an inventory tracking database.

FIG. 13 illustrates a block diagram of an example computing device 1300, according to certain embodiments. FIG. 13 is a diagrammatic representation of a machine in the example form of a computing device 1300 within which a set of instructions, for causing the machine to perform any one or more of the methodologies discussed herein above. In some embodiments, the machine may be connected (e.g., networked) to other machines in a Local Area Network (LAN), an intranet, an extranet, or the Internet. For example, the machine may be networked to a rapid prototyping apparatus such as a 3D printer or SLA apparatus. In some examples, the machine may be networked to or directly connected to an imaging system, a robot arm, a laser welder, a bonding station, and so on. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 1300 includes a processing device 1302, a main memory 1304 (e.g., read only memory (ROM), flash memory, dynamic random access memory (DRAM) such as synchronous DRAM (SDRAM), etc.), a static memory 1306 (e.g., flash memory, static random access memory (SRAM), etc.), and a secondary memory (e.g., a data storage device 1328), which communicate with each other via a bus 1308.

Processing device 1302 represents one or more general-purpose processors such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, or the like. Processing device 1302 is configured to execute the processing logic (instructions 1326) for performing operations and steps discussed herein.

The computing device 1300 may further include a network interface device 1322 for communicating with a network 1364. The computing device 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1320 (e.g., a speaker).

The data storage device 1328 may include a machine-readable storage medium (or more specifically a non-transitory computer-readable storage medium) 1324 on which is stored one or more sets of instructions 1326 embodying any one or more of the methodologies or functions described herein. A non-transitory storage medium refers to a storage medium other than a carrier wave. The instructions 1326 may also reside, completely or at least partially, within the main memory 1304 and/or within the processing device 1302 during execution thereof by the computer device 1300, the main memory 1304 and the processing device 1302 also constituting computer-readable storage media.

The computer-readable storage medium 1324 may also be used to store instructions, which may perform one or more of the operations of methods described above. The computer readable storage medium 1324 may also store a software library containing methods. While the computer-readable storage medium 1324 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, and other non-transitory computer-readable media.

As discussed herein above, in some embodiments, the inspection stations may be used to perform automated defect detection of molds of dental arches used to manufacture aligners and/or to perform automated defect detection of dental appliances.

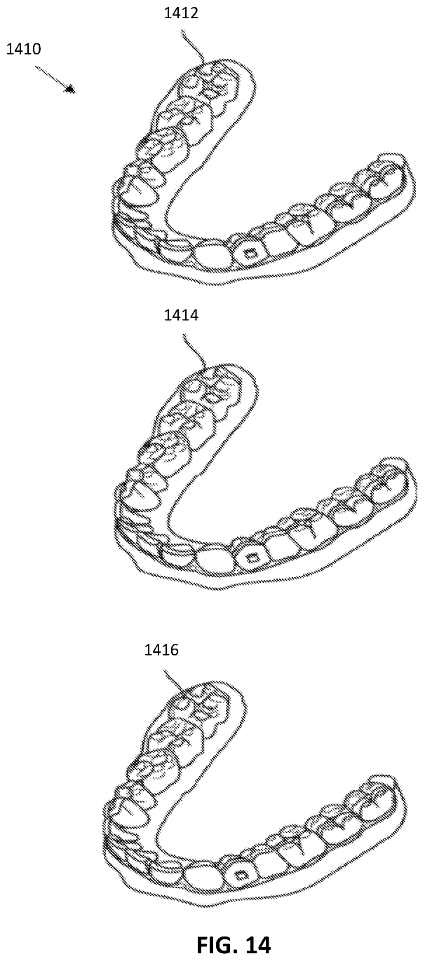

FIG. 14 illustrates a tooth repositioning system 1410 including a plurality of appliances 1412, 1414, and 1416. Appliances 1412, 1414, and/or 1416 may be formed using one or more occlusal elements 100 (e.g., occlusal blocks, dental appliance occlusal blocks) of the present disclosure.

Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1410 can include a first appliance 1412 corresponding to an initial tooth arrangement, one or more intermediate appliances 1414 corresponding to one or more intermediate arrangements, and a final appliance 1416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

In some embodiments, the appliances 1412, 1414, 1416, or portions thereof, can be produced using indirect fabrication techniques, such as thermoforming over a positive or negative mold, which may be inspected using the methods and systems described herein above. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In an example of indirect fabrication, a mold of a patient's dental arch may be fabricated from a digital model of the dental arch, and a shell may be formed over the mold (e.g., by thermoforming a polymeric sheet over the mold of the dental arch and then trimming the thermoformed polymeric sheet). The fabrication of the mold may be formed by a rapid prototyping machine (e.g., a SLA 3D printer). The rapid prototyping machine may receive digital models of molds of dental arches and/or digital models of the appliances 1412, 1414, 1416 after the digital models of the appliances 1412, 1414, 1416 have been processed by processing logic of a computing device. The processing logic may include hardware (e.g., circuitry, dedicated logic, programming logic, microcode, etc.), software (e.g., instructions executed by a processing device), firmware, or a combination thereof.

To manufacture the molds, a shape of a dental arch for a patient at a treatment stage is determined based on a treatment plan. In the example of orthodontics, the treatment plan may be generated based on an intraoral scan of a dental arch to be molded. The intraoral scan of the patient's dental arch may be performed to generate a three dimensional (3D) virtual model of the patient's dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting technologies (e.g., to design the virtual 3D mold). Alternatively, an initial negative mold may be generated from an actual to be modeled (e.g., a dental impression or the like). The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model will be different. The original virtual 3D model, the final virtual model 3D model and each intermediate virtual 3D model is unique and customized to the patient.

Accordingly, multiple different virtual 3D models (digital designs) of a dental arch may be generated for a single patient. A first virtual 3D model may be a unique model of a patient's dental arch and/or teeth as they presently exist, and a final virtual 3D may be a model of the patient's dental arch and/or teeth after correction of one or more teeth and/or a jaw. Multiple intermediate virtual 3D models may be modeled, each of which may be incrementally different from previous virtual 3D models.

Each virtual 3D model of a patient's dental arch may be used to generate customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model may include instructions that will control a fabrication system or device in order to produce the mold with specific geometries.

A clinician office, laboratory, manufacturing facility or other entity may receive the virtual 3D model of the mold, the digital model having been created as set forth above. The entity may input the digital model into a rapid prototyping machine. The rapid prototyping machine then manufactures the mold using the digital model. One example of a rapid prototyping manufacturing machine is a 3D printer. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In some instances SLA is used to fabricate an SLA mold. In SLA, the mold is fabricated by successively printing thin layers of a photo-curable material (e.g., a polymeric resin) on top of one another. A platform rests in a bath of liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as polyester, a co-polyester, a polycarbonate, a thermopolymeric polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermopolymeric elastomer (TPE), a thermopolymeric vulcanizate (TPV) elastomer, a polyurethane elastomer, a block copolymer elastomer, a polyolefin blend elastomer, a thermopolymeric co-polyester elastomer, a thermopolymeric polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

After the mold is generated, it may be inspected using the systems and/or methods described herein above. If the mold passes the inspection, then it may be used to form an appliance (e.g., an aligner).

Appliances may be formed from each mold and when applied to the teeth of the patient, may provide forces to move the patient's teeth as dictated by the treatment plan. The shape of each appliance is unique and customized for a particular patient and a particular treatment stage. In an example, the appliances 1412, 1414, and 1416 can be pressure formed or thermoformed over the molds. Each mold may be used to fabricate an appliance that will apply forces to the patient's teeth at a particular stage of the orthodontic treatment. The appliances 1412, 1414, and 1416 each have teeth-receiving cavities that receive and resiliently reposition the teeth in accordance with a particular treatment stage.

In one embodiment, a sheet of material is pressure formed or thermoformed over the mold. The sheet may be, for example, a sheet of polymeric (e.g., an elastic thermopolymeric, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell.

Additional information may be added to the appliance. The additional information may be any information that pertains to the aligner. Examples of such additional information includes a part number identifier, patient name, a patient identifier, a case number, a sequence identifier (e.g., indicating which aligner a particular liner is in a treatment sequence), a date of manufacture, a clinician name, a logo and so forth. For example, after an appliance is thermoformed, the aligner may be laser marked with a part number identifier (e.g., serial number, barcode, or the like). In some embodiments, the system may be configured to read (e.g., optically, magnetically, or the like) an identifier (barcode, serial number, electronic tag or the like) of the mold to determine the part number associated with the aligner formed thereon. After determining the part number identifier, the system may then tag the aligner with the unique part number identifier. The part number identifier may be computer readable and may associate that aligner to a specific patient, to a specific stage in the treatment sequence, whether it is an upper or lower shell, a digital model representing the mold the aligner was manufactured from and/or a digital file including a virtually generated digital model or approximated properties thereof of that aligner (e.g., produced by approximating the outer surface of the aligner based on manipulating the digital model of the mold, inflating or scaling projections of the mold in different planes, etc.).

After an appliance is formed over a mold for a treatment stage, that appliance is subsequently trimmed along a cutline (also referred to as a trim line) and the appliance may be removed from the mold. The processing logic may determine a cutline for the appliance. The determination of the cutline(s) may be made based on the virtual 3D model of the dental arch at a particular treatment stage, based on a virtual 3D model of the appliance to be formed over the dental arch, or a combination of a virtual 3D model of the dental arch and a virtual 3D model of the appliance. The location and shape of the cutline can be important to the functionality of the appliance (e.g., an ability of the appliance to apply desired forces to a patient's teeth) as well as the fit and comfort of the appliance. For shells such as orthodontic appliances, orthodontic retainers and orthodontic splints, the trimming of the shell may play a role in the efficacy of the shell for its intended purpose (e.g., aligning, retaining or positioning one or more teeth of a patient) as well as the fit on a patient's dental arch. For example, if too much of the shell is trimmed, then the shell may lose rigidity and an ability of the shell to exert force on a patient's teeth may be compromised. When too much of the shell is trimmed, the shell may become weaker at that location and may be a point of damage when a patient removes the shell from their teeth or when the shell is removed from the mold. In some embodiments, the cut line may be modified in the digital design of the appliance as one of the corrective actions taken when a probable point of damage is determined to exist in the digital design of the appliance.

On the other hand, if too little of the shell is trimmed, then portions of the shell may impinge on a patient's gums and cause discomfort, swelling, and/or other dental issues. Additionally, if too little of the shell is trimmed at a location, then the shell may be too rigid at that location. In some embodiments, the cutline may be a straight line across the appliance at the gingival line, below the gingival line, or above the gingival line. In some embodiments, the cutline may be a gingival cutline that represents an interface between an appliance and a patient's gingiva. In such embodiments, the cutline controls a distance between an edge of the appliance and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

In some embodiments, the orthodontic appliances herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances 1412, 1414, and 1416. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances 1412, 1414, and 1416 can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances 1412, 1414, and 1416 can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances 1412, 1414, and 1416. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object geometry can be used, referred to herein as “continuous direct fabrication.” Various types of continuous direct fabrication methods can be used. As an example, in some embodiments, the appliances 1412, 1414, and 1416 are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

The direct fabrication approaches provided herein are compatible with a wide variety of materials, including but not limited to one or more of the following: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, a thermoset material, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an orthodontic appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every nth build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, and then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

The direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated at the end of each build. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

Once appliances (e.g., aligners) are directly fabricated, they may be inspected using the systems and/or methods described herein above.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

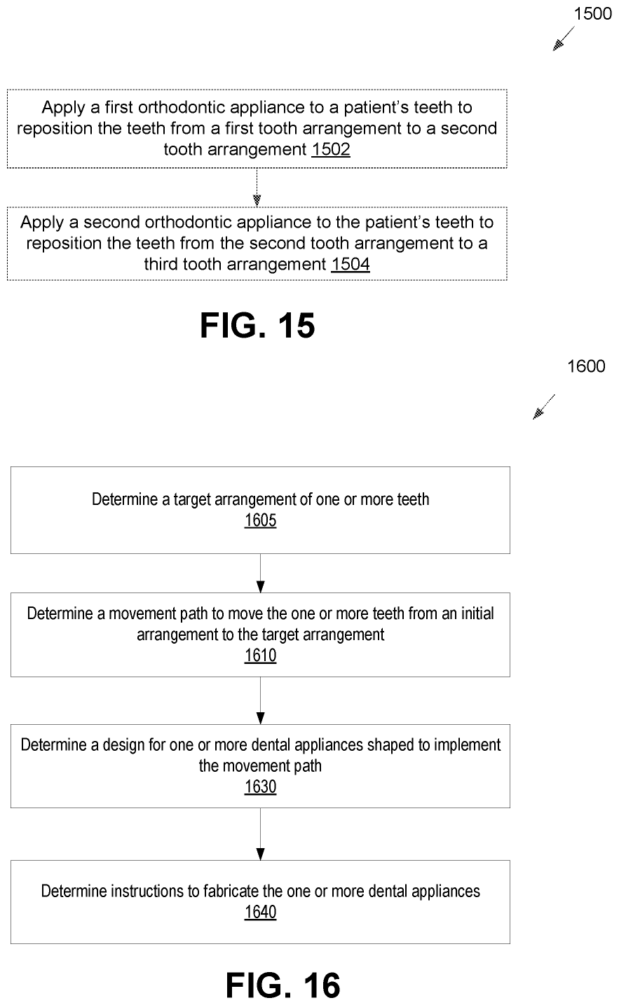

FIG. 15 illustrates a method 1500 of orthodontic treatment using a plurality of appliances, in accordance with certain embodiments. The Appliances may be formed using one or more occlusal elements 100 (e.g., occlusal blocks, dental appliance occlusal blocks) of the present disclosure.

The method 1500 can be practiced using any of the appliances or appliance sets described herein. In block 1502, a first orthodontic appliance is applied to a patient's teeth in order to reposition the teeth from a first tooth arrangement to a second tooth arrangement. In block 1504, a second orthodontic appliance is applied to the patient's teeth in order to reposition the teeth from the second tooth arrangement to a third tooth arrangement. The method 1500 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 16 illustrates a method 1600 for designing an orthodontic appliance to be produced by direct or indirect fabrication, in accordance with embodiments. The orthodontic appliance may be produced using one or more occlusal elements 100 (e.g., occlusal blocks, dental appliance occlusal blocks) of the present disclosure.

The method 1600 can be applied to any embodiment of the orthodontic appliances described herein. Some or all of the blocks of the method 1600 can be performed by any suitable data processing system or device, e.g., one or more processors configured with suitable instructions.

At block 1605 a target arrangement of one or more teeth of a patient may be determined. The target arrangement of the teeth (e.g., a desired and intended end result of orthodontic treatment) can be received from a clinician in the form of a prescription, can be calculated from basic orthodontic principles, can be extrapolated computationally from a clinical prescription, and/or can be generated by a dental appliance generator (e.g., of a processing device 1302). With a specification of the desired final positions of the teeth and a digital representation of the teeth themselves, the final position and surface geometry of each tooth can be specified to form a complete model of the tooth arrangement at the desired end of treatment.

In block 1610, a movement path to move the one or more teeth from an initial arrangement to the target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set such as a 3D model fo the patient's dental arch or arches can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, optionally including measured or extrapolated hidden surfaces and root structures, as well as surrounding bone and soft tissue.

Having both an initial position and a target position for each tooth, a movement path can be defined for the motion of each tooth. Determining the movement path for one or more teeth may include identifying a plurality of incremental arrangements of the one or more teeth to implement the movement path. In some embodiments, the movement path implements one or more force systems on the one or more teeth (e.g., as described below). In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In some embodiments, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age-for example, young juvenile patients will typically require lower forces to expand the suture than older patients, as the suture has not yet fully formed.

In block 1630, a design for one or more dental appliances shaped to implement the movement path is determined. In one embodiment, the one or more dental appliances are shaped to move the one or more teeth toward corresponding incremental arrangements. In one embodiment, the orthodontic application is determined by dental appliance generator (e.g., of a processing device 1302). Determination of the one or more dental or orthodontic appliances, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

In block 1640, instructions for fabrication of the one or more dental appliances are determined or identified. In some embodiments, the instructions identify one or more geometries of the one or more dental appliances. In some embodiments, the instructions identify slices to make layers of the one or more dental appliances with a 3D printer. In some embodiments, the instructions identify one or more geometries of molds usable to indirectly fabricate the one or more dental appliances (e.g., by thermoforming plastic sheets over the 3D printed molds). The dental appliances may include one or more of aligners (e.g., orthodontic aligners), retainers, incremental palatal expanders, attachment templates, and so on.

In one embodiment, instructions for fabrication of the one or more dental appliances are generated by dental appliance generator (e.g., of a processing device 1302). The instructions can be configured to control a fabrication system or device in order to produce the orthodontic appliance with the specified orthodontic appliance. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by 3D printing a mold and thermoforming a plastic sheet over the mold.

Method 1600 may comprise additional blocks: 1) The upper arch and palate of the patient is scanned intraorally to generate three dimensional data of the palate and upper arch; 2) The three dimensional shape profile of the appliance is determined to provide a gap and teeth engagement structures as described herein.

Although the above blocks show a method 1600 of designing an orthodontic appliance in accordance with some embodiments, a person of ordinary skill in the art will recognize some variations based on the teaching described herein. Some of the blocks may comprise sub-blocks. Some of the blocks may be repeated as often as desired. One or more blocks of the method 1600 may be performed with any suitable fabrication system or device, such as the embodiments described herein. Some of the blocks may be optional, and the order of the blocks can be varied as desired.

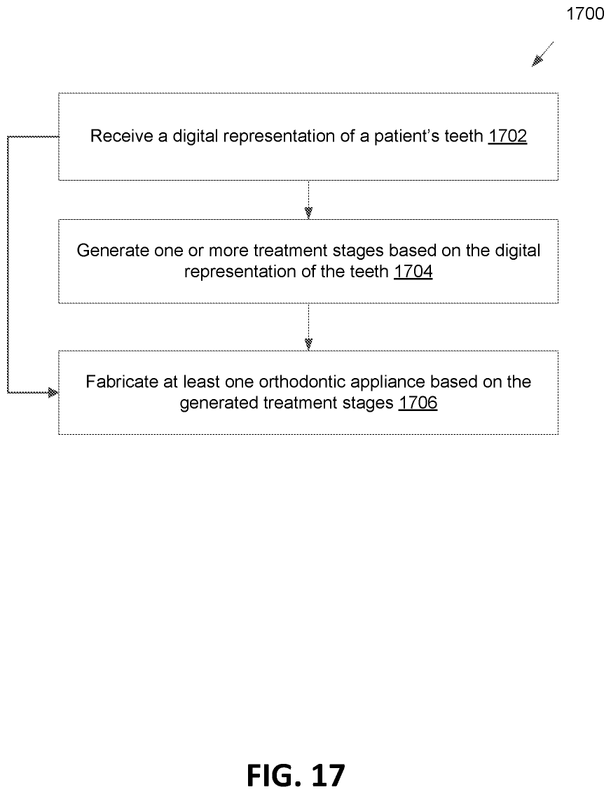

FIG. 17 illustrates a method 1700 for digitally planning an orthodontic treatment associated with a dental appliance, in accordance with embodiments. The dental appliance may be formed using one or more occlusal elements 100 (e.g., occlusal blocks, dental appliance occlusal blocks) of the present disclosure.

FIG. 17 illustrates a method 1700 for digitally planning an orthodontic treatment and/or design or fabrication of an appliance, in accordance with embodiments. The method 1700 can be applied to any of the treatment procedures described herein and can be performed by any suitable data processing system.

In block 1710, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1702, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1704, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. Design and/or fabrication of an orthodontic appliance, and perhaps a particular orthodontic treatment, may include use of a representation of the patient's teeth (e.g., receive a digital representation of the patient's teeth), followed by design and/or fabrication of an orthodontic appliance based on a representation of the patient's teeth in the arrangement represented by the received representation.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about” or “approximately” is used herein, this is intended to mean that the nominal value presented is precise within ±10%.

Although the operations of the methods herein are shown and described in a particular order, the order of operations of each method may be altered so that certain operations may be performed in an inverse order or so that certain operation may be performed, at least in part, concurrently with other operations. In another embodiment, instructions or sub-operations of distinct operations may be in an intermittent and/or alternating manner. In one embodiment, multiple metal bonding operations are performed as a single step.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A dental appliance occlusal element comprising:
a lower surface comprising one or more features configured to interface with a pick-and-place robot to cause the dental appliance occlusal element to be inserted into a hollow feature of a dental appliance;
an upper surface configured to be disposed adjacent a distal inner surface of the hollow feature; and
one or more side surfaces configured to be disposed against one or more side inner surfaces of the hollow feature.

2. The dental appliance occlusal element of claim 1, wherein the one or more features comprise a first recess and a second recess, wherein the pick-and-place robot comprises a gripper comprising distal ends configured to secure the dental appliance occlusal element via the first recess and the second recess.

3. The dental appliance occlusal element of claim 1, wherein the one or more features comprise a channel, wherein the pick-and-place robot comprises a gripper comprising distal ends configured to secure the dental appliance occlusal element via the channel.

4. The dental appliance occlusal element of claim 1, wherein the one or more features comprise a substantially planar surface, wherein the pick-and-place robot comprises a vacuum configured to secure the dental appliance occlusal element via suction of the substantially planar surface.

5. The dental appliance occlusal element of claim 1, wherein the upper surface and at least one of the one or more side surfaces comprise an identifying feature configured to interface with a corresponding feature of the hollow feature.

6. The dental appliance occlusal element of claim 1, wherein:
the upper surface is a curved surface;
the one or more side surfaces comprise a lower side surface an upper side surface; and
the upper side surface is a chamfer.

7. The dental appliance occlusal element of claim 6, wherein the lower side surface is from about 5 to about 9 degrees from vertical.

8. The dental appliance occlusal element of claim 1, wherein the dental appliance occlusal element is solid.

9. An overmolding occlusal element comprising:
an upper surface;
one or more side surfaces; and
a lower surface forming a plurality of features configured to interface with a plurality of corresponding features of a dental mold, wherein a dental appliance is to be thermoformed over the dental mold and the overmolding occlusal element.

10. The overmolding occlusal element of claim 9, wherein the upper surface is curved.

11. The overmolding occlusal element of claim 9, wherein the upper surface forms one or more recesses.

12. The overmolding occlusal element of claim 9, wherein the plurality of features comprise a plurality of recesses formed by ribbed sidewalls.

13. The overmolding occlusal element of claim 9, wherein the plurality of features comprise a plurality of angled recesses.

14. The overmolding occlusal element of claim 9, wherein the lower surface forms a stepped base configured to interface with the dental mold.

15. The overmolding occlusal element of claim 9, wherein the one or more side surfaces form recesses configured to interface with a pick-and-place robot to cause the overmolding occlusal element to be secured to the dental mold.

16. The overmolding occlusal element of claim 9, wherein the upper surface and at least one of the one or more side surfaces form a feature configured to form a corresponding feature in the dental appliance to interface with an occlusal element.

17. The overmolding occlusal element of claim 9, wherein the upper surface comprises a curved surface, wherein the one or more side surfaces comprise an upper side surface and a lower side surface, wherein the upper side surface is chamfered, and wherein the lower side surface is about 5 to about 9 degrees.

18. The overmolding occlusal element of claim 9, wherein the one or more side surfaces form a lip, wherein the lip is about 0.5 millimeters (mm) to about 1.0 mm.

19. The overmolding occlusal element of claim 9, wherein at least one of the one or more side surfaces are tapered, wherein:
the upper surface is wider than the lower surface; or
the lower surface is wider than the upper surface.

20. A dental appliance mold comprising:
a dental arch portion associated with a current or future dental arch of a user; and
an occlusal element portion comprising:
a curved upper surface; and
one or more side surfaces forming a lip that is about 0.5 millimeters (mm) to about 1.0 mm, and wherein a dental appliance is configured to be thermoformed over the dental appliance mold, wherein a hollow feature of the dental appliance is to be formed over the occlusal element portion.

21. The dental appliance mold of claim 19, wherein:
the one or more side surfaces comprise an upper side surface and a lower side surface; and
the upper side surface is chamfered, and wherein the lower side surface is about 5 to about 9 degrees.
